(19) United States
(12) Patent Application Publication
(10) Pub. No.: US 2006/0031888 A1
(43) Pub. Date: Feb. 9, 2006

(54) Centralized resource management and un-managed device support

(76) Inventor: Carlton J. Sparrell, Marblehead, MA (US)

Correspondence Address: COVINGTON & BURLING;ATTN: PATENT DOCKETING, 1201 PENNSYLVANIA AVENUE, N.W., WASHINGTON, DC, 20004-2401, US

(21) Appl. No.: 10/835,552

(22) Filed: Apr. 30, 2004

Related U.S. Application Data
(63) Continuation-in-part of application No. 10/490,225, filed on Aug. 24, 2004.
(63) Continuation-in-part of application No. 10/490,224, filed on Aug. 24, 2004.
(63) Continuation-in-part of application No. 10/490,325, filed on Jul. 23, 2004.

(51) Int. Cl. H04N 7/18

(52) U.S. Cl. 725/78; 725/133

(57) ABSTRACT

The present invention in embodiments provides a centralized resource manager and resources that are responsive to the centralized resource manager in a Home Area Network that may additionally include resources that are not responsive to the centralized resource manager. In embodiments, the centralized resource manager may control and regulate demands made by the non-responsive resources for access and use of the responsive resources. In other embodiments, the responsive resources may communicate with the centralized resource manager in cases where they are accessed or queried for access by the non-responsive resources. In yet other embodiments, the centralized resource manager may implement differing control protocols for controlling both types of resources.

### RELATED APPLICATIONS

The present patent application is a continuation-in-part of and claims the benefit under 35 U.S.C. § 120 of U.S. patent application Ser. No. 10/490,225 filed Mar. 19, 2004, entitled “Centralized Resource Manager” (Atty. Dkt. UCN-027); Ser. No. 10/490,224 filed Mar. 19, 2004, entitled “Centralized Resource Manager With Passive Sensing System For Automatic Reallocation Of Resources” (Atty. Dkt. UCN-028); Ser. No. 10/490,325 filed Mar. 19, 2004, entitled “Centralized Resource Manager With Power Switching System For Automatic Reallocation Of Resources” (Atty. Dkt. UCN-029). The entirety of each of these patent applications is herein incorporated by reference.

### INCORPORATION BY REFERENCE

The present application for United States Patent incorporates herein by reference the contents of the following U.S. patent applications:
Ser. No. 09/365,726 filed Aug. 3, 1999, entitled “Multi-Service In-Home Network With an Open Interface”;
Ser. No. 09/809,770 (Atty. Dkt. UCN-006) filed Mar. 16, 2001, entitled “Home Area Network Including Arrangement for Distributing Television Programming Over Local Cable”;
60/193,813, filed Mar. 31, 2000, entitled “Home Area Network”;
60/313,209 (Atty. Dkt. UCN-011), filed Aug. 17, 2001, entitled “Delivering Multimedia Over Home Area Networks”;
60/313,228, filed Aug. 17, 2001, entitled “Web Services Provisioning Architecture”;
60/327,627 (Atty. Dkt. UCN-012), filed Oct. 5, 2001, entitled “Home Area Network Centralized Video Recorder”;
60/345,966 (Atty. Dkt. UCN-017), filed Nov. 7, 2001, entitled “Digital Video Recording System Supporting Concurrent Playback Using Advanced Program Information”;
Ser. No. 10/017,675 (Atty.- Dkt. UCN-018) filed Dec. 15, 2001, entitled “Centralized Digital Video Recording and Playback System Accessible To Multiple Reproduction And Control Units Via A Home Area Network”;
Ser. No. 10/032,218 (Atty. Dkt. UCN-015) filed Dec. 21, 2001, entitled “Digital Video Recording and Reproduction System And Method Suitable For Live-Pause Playback Utilizing Intelligent Buffer Memory Allocation”;
60/323,618 (Atty. Dkt. UCN-016) filed Sep. 20, 2001, entitled “Home Network Platform, Architecture and System”;
60/350,431 (Atty. Dkt. UCN-019) filed Jan. 18, 2002, entitled “Home Area Network Traffic Management with a Networked Personal Video Recorder”;
60/350,431 (Atty. Dkt. UCN-032) filed Apr. 11, 2002, entitled “Centralized Resource Manager.”

### FIELD OF THE INVENTION

The present invention broadly relates to digital recording and playback systems and methods administered by home area networks. More particularly, the present invention relates to improving the flexibility of home area networks by facilitating the interoperability of resources that are not compatible with a centralized resource manager in a home area network incorporating a centralized resource manager.

### BACKGROUND OF THE INVENTION

The concept of linking multiple digital entertainment devices in a home network infrastructure has become widely accepted. It is now possible to interconnect a plurality of these devices—including televisions and video recording devices, audio recording and playback devices, personal computers, and telephony devices—in a network having sufficient bandwidth to distribute media content (e.g., movies, audio/stereo) and data throughout a home, as desired by the individual users, so that the resources of the devices may be shared. However, the sharing of these multiple devices in a home-based network presents new problems in allocating and managing the resources of the various devices in an efficient manner.

Members of the Home Audio Video Interactive (HAVi) alliance have developed a protocol for dealing with distributed devices across a bus architecture (typically IEEE 1394 or FireWire), using concepts of resource management and reservation. Under the HAVi protocol, certain devices will allow partial or total reservation of their resources. These devices include their own local resource manager component. A device wishing to reserve resources will communicate with the local resource manager associated with that device. If another device has reserved these resources, the device requesting these resources may negotiate with the resource holder by communicating messages through the local resource manager of the device in question.

Universal Plug and Play (UPnP) and Jini Network Technology (Jini) are similar resource discovery and control tools. Both of these lack any robust resource management tools. They are also implemented in a manner similar to HAVi, in that all devices are responsible for supporting the protocol, and support distributed, not centralized, interaction.

In addition, Tivo, ReplayTV, and others have developed personal video recording (PVR) products, which allow a user to digitally store television programs and other media content for later viewing. Each of these products supports the reservation of a tuner to support a scheduled recording of television shows.

Each of the above methodologies, however, is limited in several ways. Tivo and ReplayTV do not support distributed networks or distributed resources management. In each of HAVi, UPnP and Jini, the device wishing to establish a complete media pipeline/session is responsible for establishing the reservations with each of the components. This is inefficient, and can possibly result in deadlock timing situations from competing reservation requests. Moreover, only devices on the network providing local resource managers may be reserved. There is no proxy device for reserving the resources of “dumb” devices (i.e., devices having no local resource manager associated therewith) on the network. Additionally, the distributed nature results in added complexity for each device that must support a local resource manager.

A superior approach comprises a home area network (HAN) that incorporates a centralized resource manager (CRM) so that it is not necessary to rely on a plurality of local resource managers in the HAN. In this approach, only one device needs to act as a CRM. The CRM assigns network resources in the most efficient manner, and provides proxy reservations where necessary for devices on the distributed network that do not include a local resource manager.

The CRM of this approach can be linked with a media server and each client device in the distributed network. The CRM identifies, assigns, and reserves available network resources in response to user requests for processing media content so that the functionality of the distributed network is centralized, in a manner which most efficiently uses the resources of the distributed network. Managed resources can include, among others, network bandwidth, CPU allocation, TV tuners, MPEG encoders and decoders, disk bandwidth, applications, and input/output devices.

One limitation of this approach, however, is that it requires each network to provide at least one CRM-capable device. In some circumstances, it may be desirable to create devices that both work in a CRM-enabled environment, and interoperate in other environments where no CRM exists. Alternatively, it is desirable to be able to bring other devices, such as UPnP-A/V compliant devices into a network with a CRM. It is therefore desirable to provide a mechanism such that CRM-controllable devices may operate in an environment without a CRM, or that a network with a CRM is able to control devices that do not recognize a CRM.

UPnP, briefly discussed above, is one of the emerging mechanisms for control of audio/visual devices. A typical UPnP-enabled network includes “control points” and “devices”. A control point is an entity capable of controlling another UPnP-enabled device, such as a light switch, or a remote control. Not surprisingly, the device capable of being controlled could include devices such as a television. In this architecture, devices and control points discover each other using a discovery protocol (typically, Simple Service Discovery Protocol, or SSDP). Any control point is capable of controlling any other UPnP-enabled device—the user can configure the light switch to control any light on the network. A control point can control many devices, and a device may be controllable by many control points.

An extension to UPnP is the UPnP A/V Architecture. This architecture is similar to basic UPnP in that it also includes control points and devices. The difference is that UPnP A/V devices can be thought of as being either Servers or Renderers. A Server is a device capable of sending content to a Renderer, and a Renderer is capable of displaying that content. The link mechanism between the Server and Renderer is not defined by UPnP and could, for example, include an analog cable connection, an isochronous media stream over a IEEE 1394 bus, or an Realtime Transport Protocol (RTP)/ Realtime Streaming Protocol (RTSP)-type stream over an IP network. The control point is responsible for discovering the devices and configuring them according to the users wishes. For example, the control point might generate a user interface (UI) allowing the user to select content to play. The control point would populate this UI with titles discovered by querying the Server. When the user selects a program to play, the control point will set up the Server to send the content to the Renderer, and set up the Renderer to receive the content from the server.

The UPnP architecture operates in a resource environment that is unmanaged in important respects. Devices on the network offer up their services to any control point. No method of reserving resources is provided, and how a device already being controlled by a control point behaves when a second control point in the network attempts to access that device is undefined, and left to the discretion of individual manufacturers to implement as they see fit. Additionally, if a control point wants to send content from a Server to a Renderer, the control point explicitly needs to establish contact with, and configure the Server, and establish contact with and configure the Renderer. Moreover, there is no provision for reserving a plurality of resources or components for accomplishing a specific task. Also, no mechanism for reserving resources based on generic type is supported (e.g. a control point requesting “a tuner that can tune in digital cable”); instead explicit control is required to be established between a specific Server and a specific Renderer. Race conditions leading to unpredictable network response are possible when two control points attempt to simultaneously configure the same Server or Renderer in the network. Such race conditions have usually been addressed by making the system strictly user-controlled, so that the latest user-initiated control point pre-empts the previous configuration of Servers or Renderers by other control points in the network.

As discussed above, although the CRM-approach to home area networking is superior to other previously known approaches, there are a number of other approaches that have some popularity. Thus, there is a need for flexible HANs that are capable of simultaneously implementing both the CRM-approach and other approaches, such as UPnP, UPnP A/V, HAVi, Jini and others.

### SUMMARY OF THE INVENTION

In view of the aforementioned problems and deficiencies of previously known systems, the present invention in embodiments provides a centralized resource manager (“CRM”) and resources that are responsive to the centralized resource manager in a Home Area Network that may additionally include resources that are not responsive to the centralized resource manager. In embodiments, the centralized resource manager may control and regulate demands made by the non-responsive resources for access and use of the responsive resources. In other embodiments, the responsive resources may communicate with the centralized resource manager in cases where they are accessed or queried for access by the non-responsive resources. In yet other embodiments, the centralized resource manager may implement differing control protocols for controlling both types of resources.

In one embodiment, a CRM may detect a request made by a non-CRM aware resource to a CRM-aware resource in a home area network for a service from the latter resource. The CRM may then determine whether to grant permission to fulfill the request, based. If the CRM determines to grant permission, then the CRM may transmit a permission message to the CRM-aware resource to this effect.

In another embodiment, the CRM may detect a request made by a non-CRM aware resource to a CRM-aware resource in a home area network for a service from the latter resource. The CRM may then determine whether a conflict arises from granting the request. If the CRM determines that a conflict arises, then the CRM may transmit a termination message to the CRM-aware resource directing the latter to terminate providing the service.

In another embodiment, a CRM-aware resource may receive a request from a non-CRM aware resource for a service from the CRM-aware resource. The CRM-aware resource may transmit a notification message to the CRM making it aware of the request. The CRM-aware resource may also initiate the provision of the requested service to the non-CRM aware resource. In a variation of this embodiment, the CRM-aware resource may not provide the requested service until after it receives a permission message from the CRM.

In yet another embodiment, a CRM-aware resource may receive a first request for a service from a non-CRM aware resource. The CRM-aware resource may then initiate provision of the service to the non-CRM aware resource. The CRM-aware resource may then receive a request from the CRM for provision of a service to another CRM-aware resource. The CRM-aware resource may then terminate provision of the former service to the non-CRM aware resource and may initiate provision of a new service to the other CRM-aware resource.

In yet another embodiment, a CRM may implement a first control protocol for providing centralized control of one or more CRM-aware resources, and may implement a second control protocol for communicating with, requesting and providing services to one or more non-CRM aware resources.

Other embodiments of the invention are discussed in or made apparent by the following disclosure.

### BRIEF DESCRIPTION OF THE DRAWINGS

These and other features and advantages of the present invention will become apparent to those skilled in the art from the description below, with reference to the following drawing figures, in which:

FIG. 1 generally illustrates a home network having a centralized resource manager (CRM) in accordance with the present invention.

FIG. 2 shows another example of a network using the CRM of the present invention.

FIG. 3 illustrates a basic audio-video pipeline configuration suitable for use with the present invention.

FIG. 4 illustrates another audio-video pipeline configuration.

FIG. 5 illustrates yet another audio-video pipeline configuration, utilizing LAN resources.

FIG. 6 illustrates still another audio-video pipeline configuration, utilizing the resources of two clients.

FIG. 7 shows a basic block diagram of a media server and a typical client as taught in the present invention.

FIG. 8 is a block diagram of another embodiment of a CRM according to the present invention.

FIG. 9 illustrates another aspect of the present invention which includes a current sensing system to detect the ON or OFF status of a television set.

FIG. 10 illustrates an example of circuitry used to implement the current sensing system of FIG. 9.

FIG. 11 shows an example using an IR sensing system to detect the ON or OFF status of a television set to automatically control resource allocation.

FIG. 12 shows further detail of the embodiment of FIG. 11.

FIG. 13 is a flowchart of one method for prioritizing resource allocation using IR signals from the IR sensing system.

FIG. 14 is a flowchart of an alternative method for prioritizing resource allocation using IR signals from the IR sensing system.

FIG. 15 illustrates another aspect of the present invention in which an electromagnetic field sensing system is used to detect the ON or OFF status of a television set.

FIG. 16 shows further detail of the embodiment of FIG. 15.

FIG. 17 shows further detail of the embodiment of FIG. 15.

FIG. 18 illustrates another aspect of the present invention in which a power switch is used to control the ON or OFF status of a television set to facilitate the automatic reallocation of resources.

FIG. 19 illustrates an embodiment of a method for implementing a centralized resource manager.

FIG. 20 illustrates another embodiment of a method for implementing a centralized resource manager.

FIG. 21 illustrates yet another embodiment of a method for implementing a centralized resource manager.

FIG. 22 illustrates an example layout of a Home Area Network showing the differing locations of resources of the Home Area Network.

FIG. 23 further illustrates the example of FIG. 22.

FIG. 24 illustrates a flow diagram showing the interaction of a CRM, a non-CRM aware resource and a non-CRM aware resource in connection with an embodiment of the invention.

FIG. 25 illustrates a flow diagram showing the interaction of a CRM, a non-CRM aware resource and a non-CRM aware resource in connection with another embodiment of the invention.

FIG. 26 illustrates a flow diagram showing the interaction of a CRM, a non-CRM aware resource and a non-CRM aware resource in connection with yet another embodiment of the invention.

FIG. 27 illustrates a computer-implemented apparatus embodiment of the present invention and an embodiment incorporating a computer-readable medium.

### DETAILED DESCRIPTION OF VARIOUS EMBODIMENTS OF THE INVENTION

Overview of the Centralized Resource Manager: Embodiments of the present invention involve a centralized resource manager (CRM) that can be linked to a plurality of networked devices in a distributed network. One such network could be a home network having digital entertainment, computing, and communication devices. Examples of network services include audio and video processing (e.g., recording audio and/or video content for storage or real-time use), distributing audio and/or video content for real-time presentation to a user (e.g., listening to a stereo system or viewing and listening via a television set), and data and graphics processing (e.g., creation, modification, display, storage, or rendering of data or graphics by using a PC or other devices or applications). Illustrative descriptions of distributed home networks are set forth below.

In accordance with known network practice, each of the devices or functional systems in the network can have resources that can be used by the functional system in conjunction with the services it provides. In the following discussion, network devices or functional systems are divided into two broad categories: client devices and atomic devices. A client device is any functional system that includes a local resource manager that provides a mechanism for control of resources useable by that client device. Such resources can be local resources, i.e., integral to the client device, and/or remote resources, e.g., resources non-integral to the client device but available thereto via a server. An atomic device is any functional system that does not include a local resource manager.

In accordance with embodiments of the invention, while local resource managers exercise control over the set of resources useable by their respective client devices, the centralized resource manager controls not only these resources, but also the resources of atomic devices (i.e., proxy control) and the resources of the distributed network as a whole. Any conflict in the exercise of control over resources between the centralized resource manager and the respective local resource manager can be resolved in favor of the centralized resource manager.

In response to a user or agent process request to provide a service, e.g., a media processing service such as recording a movie distributed by an external provider, the centralized resource manager exercises master control over the network resources by identifying network resources that are available to fulfill the user (or agent process) request, assigning specific network resources from the available network resources to define a media pipeline or session that fulfills the user request, and reserving the network resources defining the media pipeline to fulfill the user (or agent process) request. The reserved network resources can be used immediately or scheduled for use at a future date. Once the reserved network resources have been used to fulfill the user or agent process request, the centralized resource manager frees these network resources, changing their status from “reserved” to “available”.

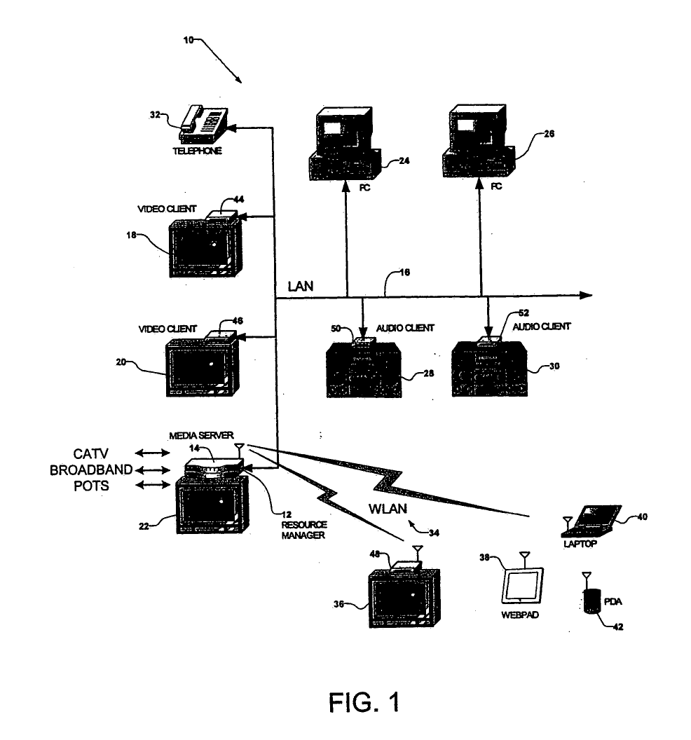

Exemplary Architectures of a CRM-Enabled Network: Referring to FIG. 1, a distributed network 10 is shown that embodies a centralized resource manager 12, which is contained within a media server 14. This centralized resource manager 12 is used in a distributed home network 10, and more specifically, in connection with home networked personal video recording and media distribution equipment. The centralized resource manager 12 also supports other client and atomic devices and services, such as PCs, telephones, network attached storage, webpads, and PDAs, interlinked with the home-based distributed network 10. In FIG. 1, the distributed home network 10 includes a LAN 16, which interlinks televisions 18, 20, 22, personal computers 24, 26, audio recording and playback devices 28, 30 and a standard telephone 32. Utilizing a wireless local area network (WLAN) capability 34, the distributed home network 10 is also shown to support links to a remote television 36, a webpad 38, a laptop computer 40 and a PDA 42.

The centralized resource manager 12 of FIG. 1 is responsible for identifying, managing and reserving network resources for client and/or atomic devices comprising the distributed home network 10. The centralized resource manager 12 can exercise master control of current network resources, and can expand the network resources by the addition of client and/or atomic devices to the distributed home network 10. Representative examples of network resources for the distributed home network 10 depicted in FIG. 1 include network bandwidth, CPU allocation, disk bandwidth, TV tuners, MPEG encoders and I/O devices. Representative examples of various client devices include set-top boxes (STBs) 44, 46, 48 for video clients and STBs 50, 52 for audio clients. Other devices can similarly be employed.

Typically, the centralized resource manager 12 is located in a gateway device that manages the LAN and WAN links of the distributed home network 10, although one skilled in the art will understand that the foregoing description does not limit the present invention. In the embodiment shown in FIG. 1, the media server 14, which includes the centralized resource manager 12, is used for storing and serving audio, video and data content across the distributed home network 10.

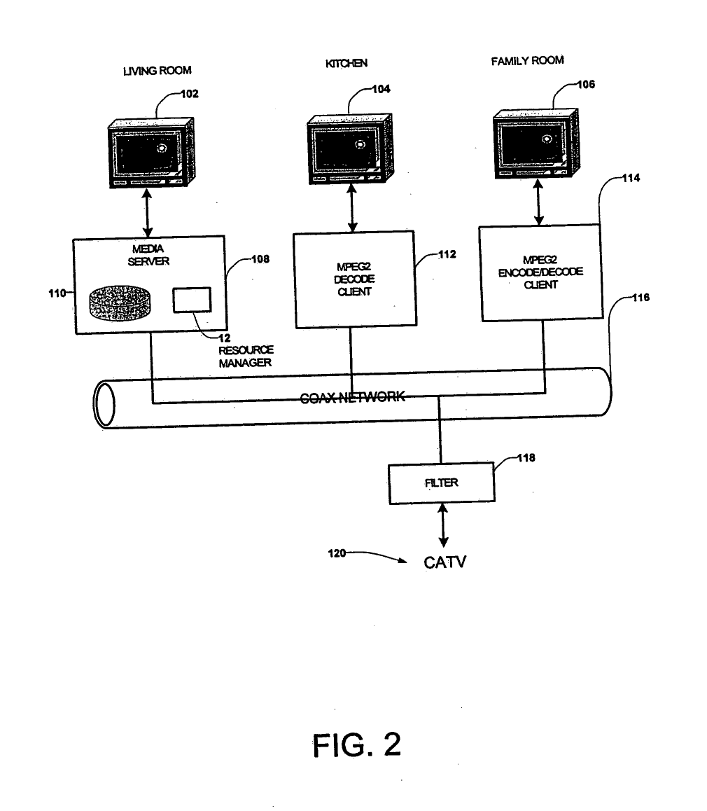

Another example of a distributed home network utilizing the centralized resource manager 12 is illustrated in FIG. 2. In particular, FIG. 2 illustrates a home-based distributed network that includes three televisions 102, 104, 106. One television 102 is connected to a media server 108. The media server 108 is capable of rendering graphics, decoding MPEG2, blending the content for display, tuning in CATV channels (analog or digital) and MPEG2 encoding audio-video streams, i.e., the media server 108 functions as a client device. The media server 108 also includes a disk storage device 110 capable of storing and retrieving MPEG2 files. A second TV 104 is connected to a video client device 112 capable of rendering graphics, decoding MPEG2 video and blending the content for display. A third television 106 is connected to a client device 114 capable of rendering graphics, decoding MPEG2 video, blending the content for display, tuning in one CATV channel 120 (analog or digital) and MPEG2 encoding of analog content.

The distributed network 116 comprises a typical 75-ohm coaxial cable used to deliver analog and digital cable channels through splitters to televisions, VCRs, etc. A LAN functionality is superimposed over the coax using frequency division multiplexing (e.g., using frequencies above or below the CATV channels for a general purpose data link). In this example, this network is Ethernet-over-coax, but other solutions exist, such as IEEE 1394 over coax, or HPNA over coax. In some topologies, a filter 118 may be required to prevent the data network frequencies from reaching outside the home.

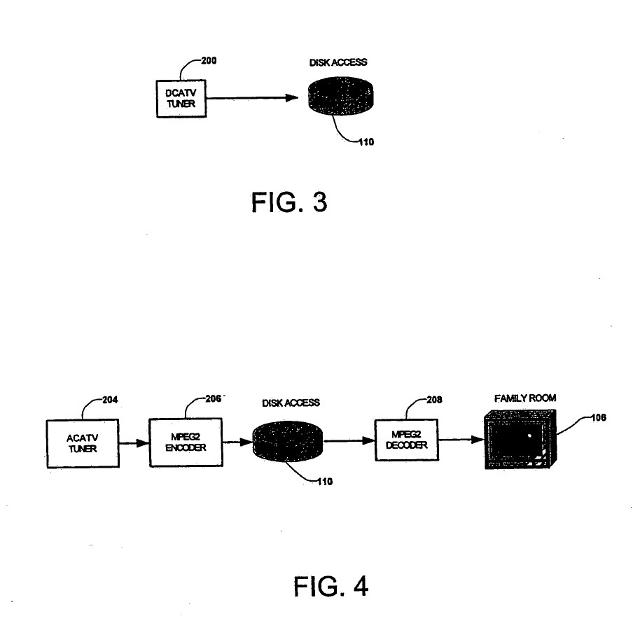

Examples of Operation of a CRM-Enabled Network: A method of controlling audio-video network resources of a distributed network by means of a centralized resource manager will now be described. Consider an evening of family television viewing. Earlier in the day, Dad programmed a client device to record the hockey game (media content) at 8:00 PM on channel 150 (the user request). Dad used a graphical user interface (GUI) to navigate to the Electronic Program Guide (EPG) application of the client device and selected the game to record. The centralized resource manager includes a scheduling application that requests a reservation of an audio-video pipeline or session with the resource requirements shown in FIG. 3, i.e., as defined by the user request.

Referring now to FIG. 3, which shows a DCATV Tuner 200 and a disk storage medium 110, the resource requirements can be described in the following manner. Since the hockey game is on a digital channel, the request is made for a digital-capable tuner 200. Further requirements may be made on this tuner, such as it has an associated Conditional Access module enabling that tuner to tune to the appropriate channel. The reservation also requires access to the disk 110 to record the hockey game (such as by writing to a disk file). This requires two types of reservation: disk bandwidth and disk capacity.

The centralized resource manager 12 will search the resource database to identify available network resources that match the resource requirements imposed by the user request. In the system described, there is one disk 110 (and more specifically one partition for video reported to the centralized resource manager 12) and three tuners. In this example, all three tuners have the same capabilities, and are distinguished only by their location in the distributed network. The centralized resource manager 12 implements a resource protocol, e.g., a least-cost algorithm, for constructing the media session or pipeline, i.e., identifying available network resources, assigning available network resources to fulfill the request, and reserving the assigned network resources. Using one of the two tuners associated with the media server 108, the media pipeline can be constructed without using network bandwidth. By using the tuner in one of the client devices 112, 114, in contrast, the centralized resource manager 12 would need to reserve network bandwidth. There is no cost difference between the two local tuners associated with the media server 108, so the lower number one is chosen.

The centralized resource manager 12 checks the disk storage device 110 for disk space both when the user schedules the recording and shortly before the recording event. If insufficient disk space is available when the user schedules the event, the centralized resource manager 12 checks to see if the disk storage device 110 includes any “delete-able” files. If all the files on the disk storage device 110 are marked as “do not delete”, the user will be alerted that the user request cannot be fulfilled (scheduled) due to insufficient recording space on the disk storage device 110. If sufficient disk space is available (or there are deleteable files), disk space will be reserved at the time of the request by the centralized resource manager 12. However, disk space will not be created (by deleting files) until the time the recording is scheduled to begin.

The centralized resource manager 12 also reserves disk bandwidth for the recording at the time the recording is scheduled. Upon successful reservation of the required network resources, the reservation is stored in a network resource reservation table for use in comparison against future user (or agent process) requests. Reservation of network resources to fulfill any request, i.e., the media pipeline or session, is communicated back to the scheduling application with a reservation id for the specific event.

At 7:30, the children want to watch a show in the family room. This television 106 is associated with the client device 114 with the MPEG2 encoder 206. The show they want to watch is on analog channel. They select this program from the EPG and the scheduling application contacts the centralized resource manager 12 to request network resources. FIG. 4 illustrates the resulting situation.

As shown in FIG. 4, the end of the pipeline or session is the video display of television 106. More specifically, the requested media pipeline needs to terminate with the display on the family room set 106. The video compression/decompression functionality supported by the distributed network is MPEG2. The media pipeline needs to decode MPEG2 by means of an MPEG2 decoder 208 prior to video display. Live-pause functionality is requested, so a network resource requirement imposed by the user request includes elastic recording to the disk storage device 110. Prior to recording on the disk storage device 110, the video needs to be encoded with an MPEG2 encoder 206. The channel requested is available in the analog spectrum, so an analog tuner 204 is required.

Note that with the exception of the video output display provided by the television set 106, the requested pipeline is not limited by the location in the distributed network where the network resources are located. The centralized resource manager will use resource protocols, e.g., least cost-of-bandwidth algorithms, to determine which network resources are assigned to fulfill the user request.

Bandwidth requirements for un-encoded video are high, so the MPEG2 decoder 208 chosen is the decoder in the client device 114 (see FIG. 2) attached locally to the family room television 106. Similarly, the MPEG2 encoder 206 needs to be local to the analog tuner 204. There are two available tuners on the system; one in the media server 108 next to the living room television 102, and one in the family room in the client device 114. While the tuner in the family room is local to the set 106, the video content needs to be written to the disk storage device 110 in the media server 108. The least-cost algorithm leads the centralized resource manager 12 to assign the tuner/encoder pair in the media server 108 to the media pipeline, thereby eliminating the requirement to write encoded data twice across the distributed network. This method preserves more network bandwidth for other uses such as data transfers between PCs linked to the distributed network. It should be obvious to those skilled in the art that algorithms other than least-cost can be used to assign the network resources to fulfill a user (or agent process) request.

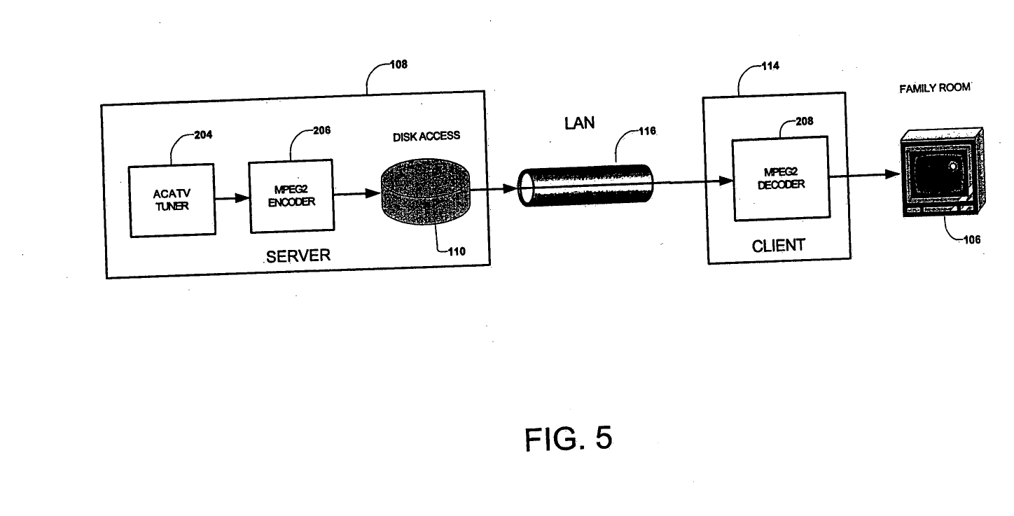

Once the centralized resource manager 12 has successfully mapped the requested media pipeline to available network resources, an instantiated graph is returned to the scheduling application, and the assigned resources are marked as reserved (indefinitely). The centralized resource manager 12 has assigned one other resource to the graph, as shown in FIG. 5. Referring now to FIG. 5, it will be understood that the LAN connection is required to connect the resources of the media server 108 to the resources of the client device 114. The LAN 116 is a managed network resource, and for this pipeline bandwidth is reserved for the video content.

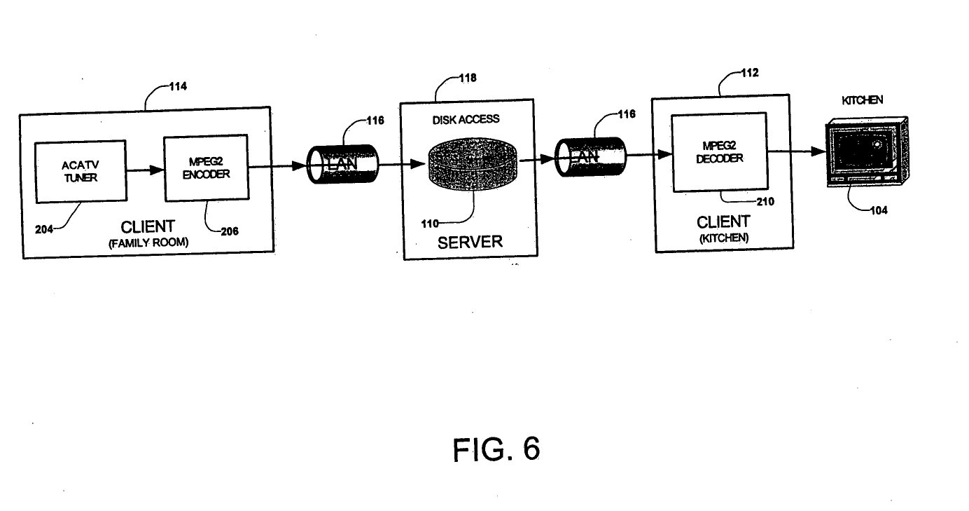

At 7:45, Mom wants to watch a program in the kitchen. The television 104 in the kitchen is connected to the decode-only video client device 112 (see FIG. 2). The centralized resource manager 12 asks for a second media pipeline or session identical to that described in connection with FIG. 4. In this case, however, the only tuner available in the distributed network is the tuner 204 in the client device 114 in the family room. The centralized resource manager 12 completes the media pipeline or session as shown in FIG. 6. In this example, two network resources 116 need to be added to the media pipeline, and twice the bandwidth reserved on the distributed network.

At 7:50, the distributed network prepares to record the hockey game. Most of the network resources have been reserved, but the centralized resource manager 12 needs to verify that disk space is available on the disk storage device 110. If there is not sufficient disk space to record the program, existing files will need to be deleted. If disk space cannot be made available (user has marked all existing files as “do not erase”), an exception will be generated and the recording will not take place. Typically, an alert is displayed on the television screens allowing the user to make room on the disk storage device 110.

At 8:00 the recording of the hockey game takes place.

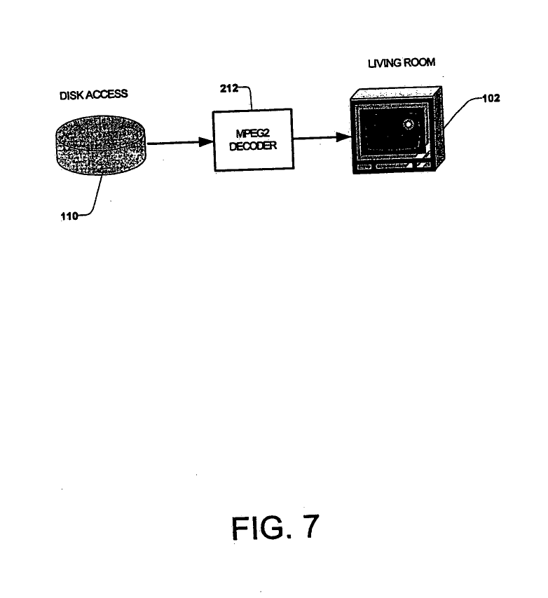

At 8:05, Dad sits down in the living room to watch a program on television 102. If a program is selected by the EPG, a request for network resources similar to that shown in FIG. 4 will be made of the centralized resource manager 12. In this case, there are no more tuners available in the distributed network. The centralized resource manager 12 will alert the user (Dad) of this information. Dad now has the option of watching one of the streams in progress, such as the hockey game, or watching a previously recorded show. Navigating the video library, Dad selects a James Bond movie recorded earlier that week. An updated request for resources, as shown in FIG. 7, is now requested via the centralized resource manager 12.

There is an MPEG2 decoder 212 available in the network resources, and provided disk bandwidth is available, the centralized resource manager 12 would assign and reserve these network resources as a media pipeline that would allow Dad to view the James Bond movie on television 102.

There is one more option that Dad could have chosen. He could have requested to “steal” a tuner from one of the other media pipelines, i.e., utilizing a network resource (tuner) that had previously been reserved by the centralized resource manager 12. While this approach probably would not endear Dad to others in this scenario, there are cases where such behavior may occur. For example, in the typical home-based distributed network, a centralized resource manager has no way of knowing when any particular TV is on or off. If Mom turns off the TV in the kitchen, without indicating this action to the centralized resource manager, the tuner associated with the kitchen TV is still allocated to the media pipeline she requested. Rather than force someone to go to the kitchen and free up the tuner, the GUI is configured to allow another user to appropriate network resources from another media pipeline. The scheduling application communicates with the centralized resource manager 12 to tear down the previously instantiated graph (media pipeline) and re-allocate the network resources to the current media request. One method of alleviating this is to allow the client device to be turned off or put in a standby mode. Other methods, including ways of indicating, to the centralized resource manager 12, which network resources can be freed up, are discussed below.

Each of the media pipelines described above can be torn down when they are no longer needed, e.g., when particular requests have been fulfilled. For example, the network resources for fulfilling a recording request, such as the tuner 200, can be freed up when the scheduled recording of the hockey game is completed.

Note that this example specifically illustrates the negotiation of network resources to build a media pipeline or session. Similarly, the centralized resource manager 12 allows reservation of network resources for audio (music) and graphics pipelines. Typically, a graphics pipeline is established at boot time or when a new client/atomic device is added to the distributed network. The graphics network resources are reserved and the graphics pipelines instantiated to allow applications running on the media server 108 and rendered on the client devices, or applications running on the client devices accessing data on the WAN or LAN 116 to reserve necessary network resources to provide the GUI and application services necessary to fulfill a particular user request.

Also note that this example specifically illustrates negotiation of a partial set of network resources to build a complete pipeline. The centralized resource manager 12 may not explicitly manage all segments of a pipeline. For example, a PCI bus connecting only an IDE hard-drive interface to an Ethernet network interface may provide far greater bandwidth than the network or hard-drive interfaces can support. In this case, reservation support of the PCI bus bandwidth may not be necessary in order to construct a resource pipeline. It should be apparent to those skilled in the art that the centralized resource manager described herein may be used to allow reservation of one or more of the resources necessary to build a network pipeline.

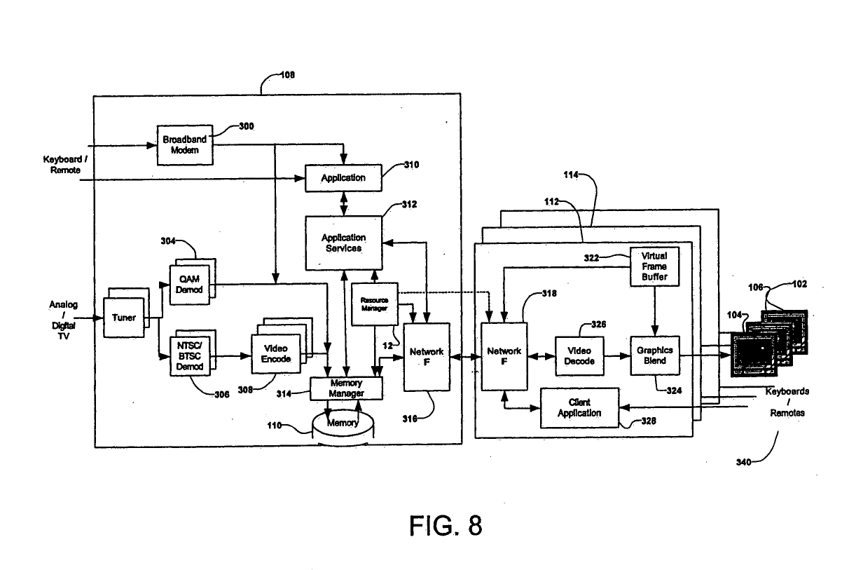

Media Server: FIG. 8 shows a block diagram of the media server 108 and client devices 112, 114 of one described embodiment of a distributed network according to embodiments of a CRM-enabled network. In some embodiments, the centralized resource manager 12 is contained in the media server 108. The media server 108 accepts CATV (both analog and digital) as well as broadband (cable modem, xDSL, etc.) WAN connectivity. In some embodiments, there is also a link to subscriber-to-subscriber POTS telephony service. The media server 108 is illustrated as the left half of FIG. 8. Digital cable typically enters the distributed network as a QAM modulated transport stream containing several MPEG2 program streams and is received by a tuner 302. The QAM content is demodulated, and the MPEG2 stream is de-multiplexed to provide the stream or streams of media content. A conditional access module may be required to decrypt the digital cable stream prior to the data being available for display or storage to disk storage device 110. The data may be re-encrypted prior to being written to persistent storage such as the disk storage device 110. Some conditional access methods allow data to be stored in the original encrypted format and decrypted just prior to display.

Analog CATV also enters the distributed network through the same interface, or through a secondary interface. In a cable system interface to the distributed network, both DCATV and ACATV typically share the same coax network using frequency division multiplexing. In satellite systems, all content provided to the distributed network is in digital format, but local terrestrial broadcast may enter the distributed network through a separate analog feed.

Analog content needs to be encoded 308 prior to being stored or transmitted. Typically this is done with MPEG2 encoders, although various other encoders are known in the art (MPEG4, wavelet, etc.). In some applications, this content will also be encrypted prior to persistent storage on the disk storage device 110.

The media server 108 described here also contains a broadband interface for receiving digital content such as TCP/IP or UDP/IP packets. This is typically through a cable modem 300 or xDSL link, but many other technologies are known in the art. This link provides data for applications running on the media server 108 or elsewhere on the distributed network. It also provides shared internet connectivity for PCs linked to the network. Digital video may also be received in the distributed network encoded in MPEG2 or some other format. Digital telephony may also be received in the distributed network as in Voice over IP or packet cable.

In an embodiment of a CRM-enabled network, the media server 108 is capable of running representative applications 310, 312. These applications 310, 312 can render graphics either locally on a connected television or remotely on client devices attached to a television. The applications 310, 312 can also render graphics suitable for other client devices such as PCs, PDAs and webpads. In one embodiment of a CRM-enabled network, these graphics are rendered using X-windows calls across the distributed network. In another embodiment, a remote frame buffer protocol such as VNC is used. In another embodiment, HTML is used for rendering. Other methods are known in the art. In yet another configuration of the distributed network, the client devices are capable of running their own applications 328.

As noted above, the centralized resource manager 12 provides centralized control over user requests for media, computing and communication services. In the embodiments described above, the centralized resource manager 12 is depicted as part of the media server. In other configurations, the resource manager 12 can exist on any client device of the distributed network. It is only necessary that client and/or atomic devices wishing to use network resources be able to communicate with the centralized resource manager 12 via the distributed network. This can be done using sockets or other methods known in the art.

Client Devices: Video client devices 112, 114 typically provide a video decoder 320, a frame buffer 322, alpha blending 324 and encoding 326 for analog output as exemplarily illustrated in FIG. 8. These client devices receive video content via the distributed network, and graphics content via the distributed network. The video content is decrypted (as needed) and decoded before being alpha blended with the graphics content. The graphics content provides a GUI. The video client devices 112, 114 also typically provide audio support to decode the audio content accompanying the video content and outputting it to a television or other audio capable output device (e.g., speakers). Video client devices 112, 114 also receive input, typically from IR-remotes or keyboards 340, but other technologies may be used.

In an embodiment, the media server 108 provides the services of a single video client device. This allows a television to be directly connected to the media server. In another configuration, the media server 018 is placed in a closet or basement, and only client devices embodying a video-display capability can display video.

In another configuration, video client devices capable of encoding video as well as decoding video are part of the distributed network. These devices are capable of tuning into digital and/or analog content and encoding the video and directing this video either back to the media server, or directly to the local decoder. This configuration allows the number of tuners to be incremented as video client devices are added to the distributed network.

NAS and Other Storage: In some distributed networks, network attached storage will also be used. In this configuration, one or more disk storage devices may reside on the distributed network. These disk storage devices are capable of receiving content from any source or streaming content to any sink. This content includes audio, video, still images and other data.

Wireless and Other Variations: In some homes there may be more than one type of distributed network. For example, there may be both wired and wireless aspects to the distributed network. There may also be a LAN and local buses such as IEEE 1394. The centralized resource manager 12 is capable of communicating to any client and/or atomic devices on the various wired and wireless aspects comprising the distributed network.

The centralized resource manager 12 is capable of reserving network resources, e.g., disk space, memory, and network bandwidth, on multiple parts of the distributed network using various methods such as TDMA networks, which are known in the art.

Dedicated applications 310,312 capable of interacting with the centralized resource manager 12 may be used to control the allocation of some network resources, such as network bandwidth. In other cases, 3^{rd} party applications may be running on client devices such as PCs. These client devices may be forced to route their traffic through bandwidth shaping components, such as those described in the patent applications listed above and herein incorporated by reference.

The centralized resource manager 12 is also responsible for detecting what network resources are available on the distributed network, and discovering when new client and/or atomic devices are added to the distributed network. Many protocols supporting this function are known in the art, such as Simple Service Discovery Protocol (SSDP), which is a component of UPnP. If client and/or atomic devices are removed from the distributed network without notifying the centralized resource manager, the scheduling application or the OS can be adapted to indicate an exception when the media pipeline is broken. The centralized resource manager 12 will then be contacted and the local resources of the removed client and/or atomic devices can also be removed from the network resource pool.

Individual hardware components typically have associated software management components that provide both control and data interfaces. For example, the client video decode resource 326 (see FIG. 8) may embody a hardware MPEG2 decoder and associated buffers. Associated software components provide a data and control interface that supports a digital video streaming data and control protocol (e.g., RTP/RTCP/RTSP). It will be apparent to those skilled in the art that the granularity of this resource management can be adjusted without limiting the present invention.

External Control for Reservation of Network Resources: As noted previously, resources of the distributed network may be requested as the result of either a user action or an agent request. In some systems, the media server or other components may be providing a service through an agreement with a broadband service provider. In some cases, it may be advantageous for the service provider to use the centralized resource manager to reserve or request resources independently of the user. For example, a service provider may wish to reserve a tuner and/or disk space at a certain time to push special media content, advertisement, or software upgrade data. In this case, an agent process residing on an Operations Support System at the service provider Network Operations Center (NOC) will generate reservation requests and communicate such requests to the centralized resource manager using a protocol such as the Simple Network Management Protocol (SMNP) over a WAN interface. Other means of configuring the home equipment and resources are known in the art.

Current Sensing system for Automatically Reallocating Network Resources: As noted previously, one constraint of the distributed network described above is that the centralized resource manager does not know when a particular TV is turned off or on. If this information is not known, the centralized resource manager may assign resources such as television tuners used in a media pipeline or session to deliver video to a television that has been shut off. One solution proposed above is to allow the user to turn the client device (and/or media server) into a standby mode. The resources associated with the client device (or media server) would still function if useable by the rest of the distributed network, but specific resources dedicated to that TV would be powered down. One problem with this approach is that many users do not turn off entertainment components, as they do with television sets.

By adding a current sensing system to any client device (and/or media server) having a television set associated therewith, and configuring the client device such that the television is operatively integrated with the current sensing system, which in turn was plugged into a wall outlet, the current sensing system provides indications as to when the TV is in an ON state and when it is in an OFF state. This current sensing system could be contained in the client device (or media server), or it could be contained in an external transformer power supply, or it could be a sensor that wraps around the television cord.

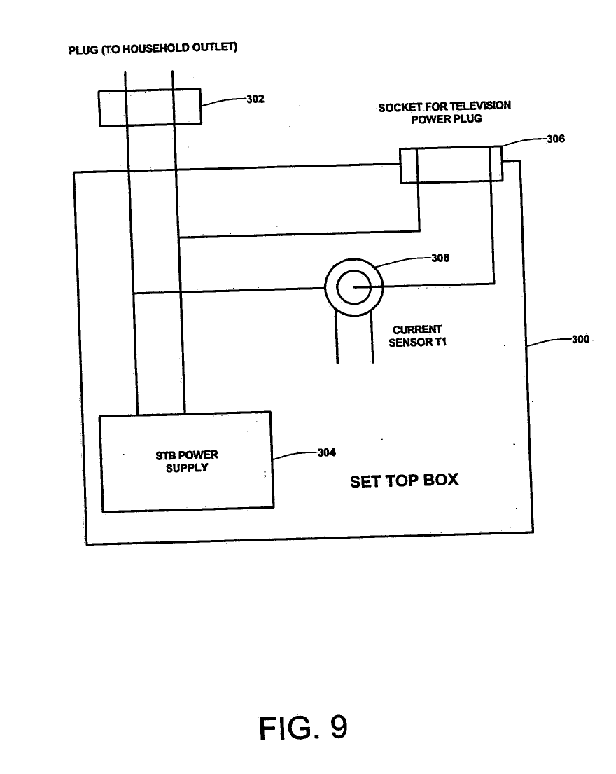

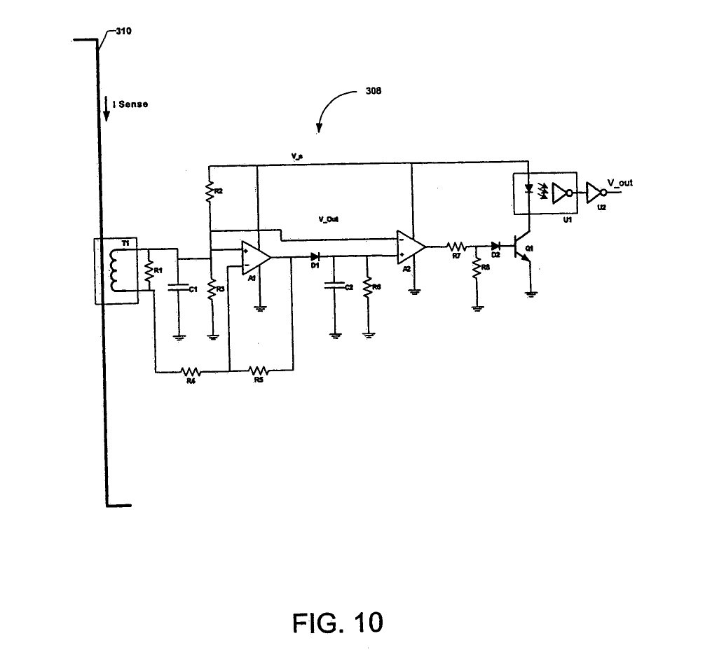

FIGS. 9 and 10 show the design and implementation of one embodiment of a current sensing system 108 according to embodiments of a CRM-enabled network, which can perform the functionality described above. Other circuits for current sensing systems are known in the art. Thus, one can combine such a current sensing system with the centralized resource manager and use the data from the current sensing system to determine the reallocation of network resources. Adding this current sensing system to other resource management schemes, such as HAVi, would also be an improvement over conventional systems.

Referring now to FIG. 9, this aspect of the CRM-enabled network is a current sensing system 308 that can be used in an STB 300 or similar client device to detect the ON and OFF states of the television to which the STB 300 is connected. The STB 300 is connected to the AC power (in the United States, typically 110 volts AC) by means of a standard power cord plug 302. The STB 300 includes a power supply 304. A connection is made from this power source to an outlet 306 on the STB 300 to which the television power cord is connected. Thus, the television will draw its current through this connection in the STB 300. One of the power conductors going to the outlet is passed through the current sensing system 308, allowing the circuit shown in FIG. 9 to sense the current and thus determine whether the television is in the ON or OFF state. In FIG. 9, the STB 300 power cord 302 plugs into an AC current outlet in the wall. The television power cord plugs into the outlet 306 furnished on the STB 300. The current sensing system 308 includes a current sense transformer T1 that is inserted in the path of the current that would be drawn by the television. The transformer T1 allows the current drawn by the television to be sensed by a circuit connected to it. This gives an indication to the STB controller as to the state of the television, whether in the ON or OFF state. For purposes of clarity, the ground wires are not shown in FIG. 9.

FIG. 10 shows an implementation of the current sensing system 308. The heavy wire 310 is the AC power connection whose current is being sensed. Typically, this wire will pass through the center of a toroid forming transformer T1 with a one-turn primary and a secondary of about 300 turns. The transformer T1 outputs about 10 mV per 1 Amp of current. Since the output of the transformer T1 is so low, an amplifier is used to boost the signal so that an accurate threshold can be set.

A resistance R1 is the load resistor for the secondary of the transformer T1. Operational amplifier A1 amplifies the voltage across T1 by a ratio of R5/R4. This ratio is chosen to exceed the turn-on voltage of diode D1, allowing the peak detection circuit formed by capacitor C2 and resistor R6 to charge. Operational amplifier A2 serves as a comparator driving current through the voltage divider formed by resistors R7 and R8, which are chosen to set a voltage at the anode of diode D2 to turn on transistor Q1. Transistor Q1 drives the opto-isolator circuit U1 producing a digital output logic low signal. An additional inverter U2 is provided to create a digital signal at V_out which is logically high when current is sensed on 310 (television in the ON state) and logically low when no current is sensed (television in the OFF state).

Referring to FIG. 10, the signal V_Out from the device U2 can be sampled by a computer or embedded controller. Having this current sensing system 308 in the STB 300 enables the computer or embedded controller to exercise discretion with regard to several functions that should not be implemented when the television is in ON state. For example, the software or firmware in the STB 300 can be upgraded when the television is in the OFF state, instead of at an arbitrary time of day. This would ensure that the user will not be inconvenienced by such an upgrade event.

IR Sensing system for Prioritizing Resource Reallocation

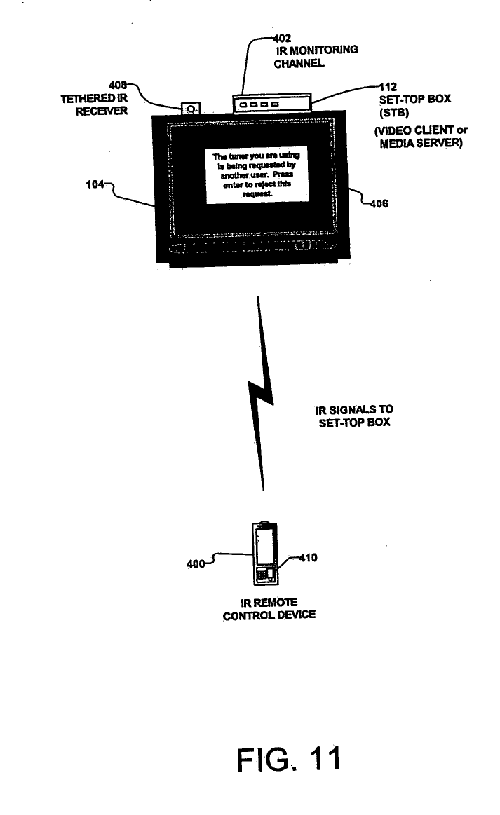

Turning now to FIGS. 11 through 14, another embodiment of a sensing system is shown, which detects signals from a typical remote control unit 400 (conventionally IR signals although RF signals can be used) to determine whether resources 404 associated with a client device 112 (or media server 108) may be automatically reallocated. Note that the resources 404 associated with client device 112 (or media server 108) may be physically located at various locations across the distributed network.

In a system that lacks a current sensing system of the type described above, a need exists to make an educated guess as to whether a particular television or other resource is in use. One means for making this guess is based on examining the signal (IR typically) detector/receiver in the room where the particular television or other resource resides.

For example, if a viewer of one television is requesting a tuner, and if all tuners are in use, and if more than one tuner is in use in a media pipeline to a television set, the ideal solution is to reallocate a tuner 404 that is used by a television 104 that is actually turned off. The centralized resource manager 12 will guess which television is most likely turned off and issue an alert to that screen.

One possible alert is a graphical pop-up window 406 (see FIG. 11), which can signal as follows: “The tuner you are using is being requested by another viewer. Press enter to reject this request.” If a user is watching this television 104 (a viewing session), he/she can be given a certain amount of time to reject the request. If after, say, one minute, there is no response, the centralized resource manager 12 will reallocate that tuner 404.

The drawback to this scheme is that many users would prefer not to see alerts 406 popping up on their screens. By making a considered determination as to which televisions are not in use, the centralized resource manager 12 can first start by alerting a screen that has a high probability of being turned off. If that screen is in use, the central resource manager 12 will then try to reallocate the resources associated with the next-most likely powered down screen.

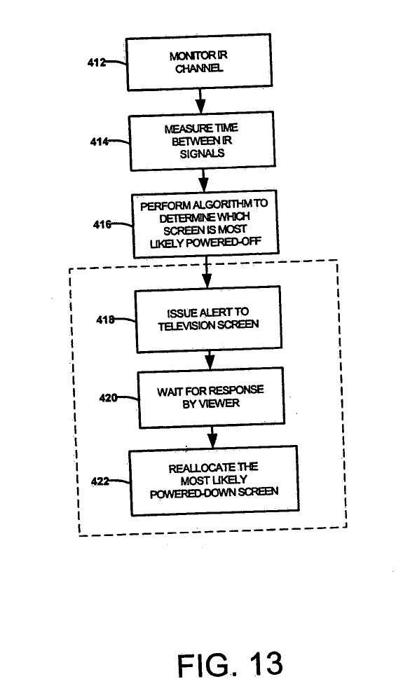

The centralized resource manager 12 can make a considered determination as to the likelihood a screen of television 104 is being watched by monitoring the IR channel 402 (detector/receiver) of the associated client device 112 (or media server 108), one method for reaching such a considered determination being shown in FIG. 13. The IR channel 402 is monitored in a first step 412. The time between received IR signals is measured at step 414. If there has been recent IR activity in the vicinity of the TV 104, there is a high probability that a user is watching and interacting with the TV 104. Conversely, if there has been no IR activity for several hours, there is a high probability that nobody is watching the television 104. An algorithm based on time-between-signals will determine whether the screen of the television 104 is most likely powered off at step 416. Only when a determination has been made at this step 416 that the television 104 is in the OFF state will an alert be issued in step 418 to the screen of the television 104, a response waited for (for a predetermined period of time) in step 420, followed by reallocation in step 422 of the resources 404 associated with the television 104 if no response is received.

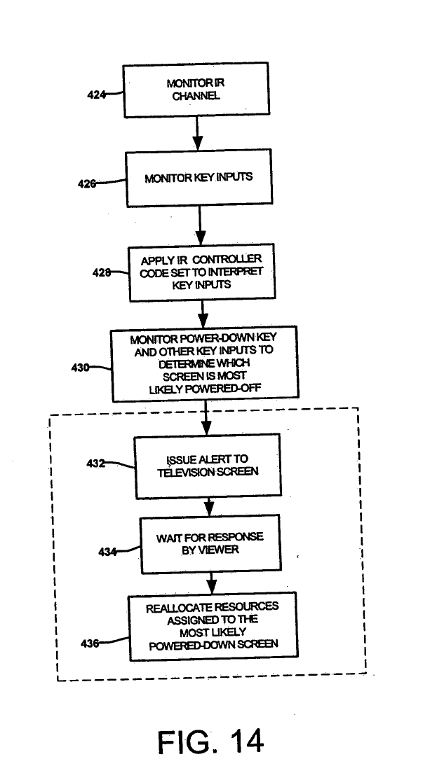

More advanced techniques can be employed, as shown in FIG. 14, such as monitoring the actual key inputs transmitted by the IR remote control device 400. For example, if there has been recent activity, but the most recent IR signal is from a power down key 410 for TV 104, there is a greater chance that the local TV 104 is off. (The chances of this are in fact greater than if a television IR control 400 has experienced no activity for an hour or so, since the viewer may be engrossed in a program and not interacting with the session). Operational aberrations militate against using the on/off signal to the TV 104 as the exclusive technique for determining whether the TV 104 is in the ON or OFF state.

For example, the IR monitoring channel 402 could detect the IR “On” signal at the same time the TV 104 does. But the IR signal to the IR monitoring channel 402 could be blocked when the TV 104 is turned off. The IR detection circuit within the channel 402 would then be out of sync. This is why other key presses in combination with the On/Off signal are useful. This method is shown in FIG. 14.

In one embodiment of this aspect of a CRM-enabled network, the sensor of the IR monitoring channel 402 is the same one used to receive signals targeted at the client device 112 (or media server 108). In an alternative embodiment, a physically separate, tethered receiver 408 can be employed as the IR signal sensor.

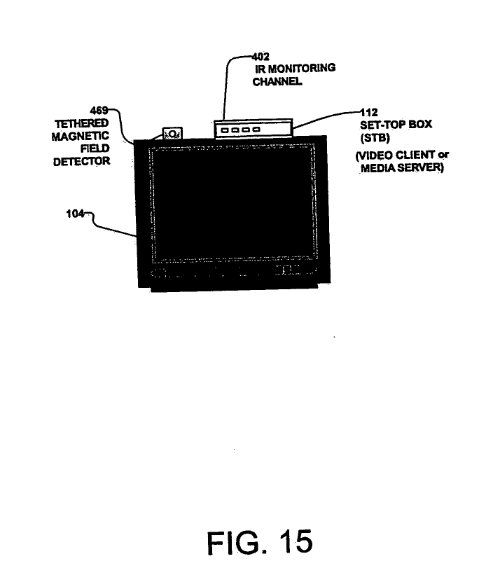

In another embodiment of this aspect of a CRM-enabled netowork, there is included a means for learning the On and Off codes (or common On/Off code) of the remote control unit (secondary) used for the television. It may be preferable that such a means be operative to learn the complete code set for the television. One method is to allow the user to enter the model number or an ID cross-referencing the model number of the TV into such means. Another method is to put the means in learn mode and to press the key to be learned. In the method depicted in FIG. 15, the key inputs are monitored in a step 426, the code set for that particular IR remote control 400 is applied at step 428 to correlate the key inputs with the IR control signals generated by the IR remote control unit 400, and the power down key and other key inputs are monitored to determine which television screen is most likely powered off at a step 430. A screen alert is then issued at step 432, a response waited for in step 434, followed by reallocation of the resource 404 in a step 436 if no response to the screen alert is received.

Note that this method would also be applicable to systems such as HAVi. For example, if a service were negotiating whether or not to steal resources, one method for determining which resource to target would be based on usage of this information.

Electro-Magnetic Field (EMF) Sensing for Prioritizing Resource Reallocation

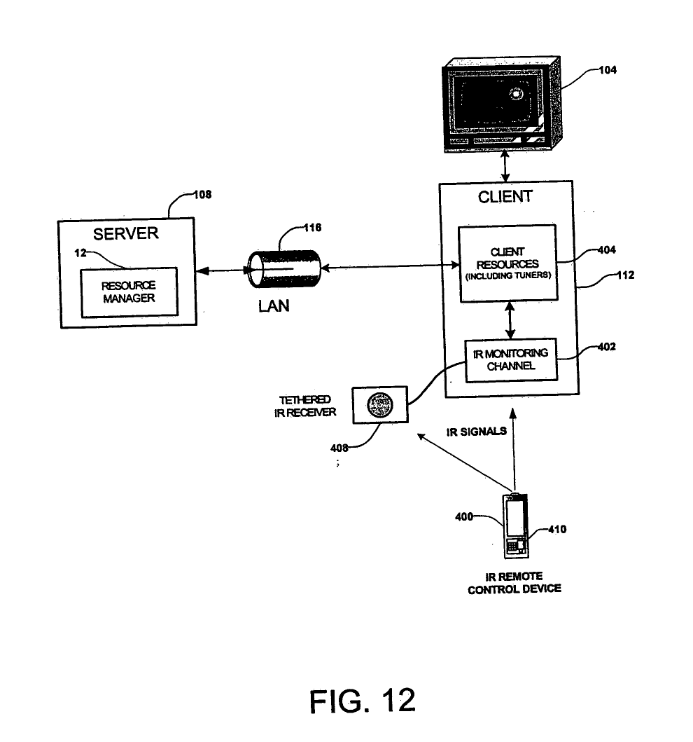

Turning now to FIGS. 15 through 17, another sensing embodiment is shown, which detects the electromagnetic filed (EMF) emitted from a television 104 to determine whether resources 404 (see FIG. 12) associated with a client device 112 (or media server 108) may be automatically reallocated. Note that the resources 404 associated with the client device 112 (or media server 108) may be physically located at various locations across the network.

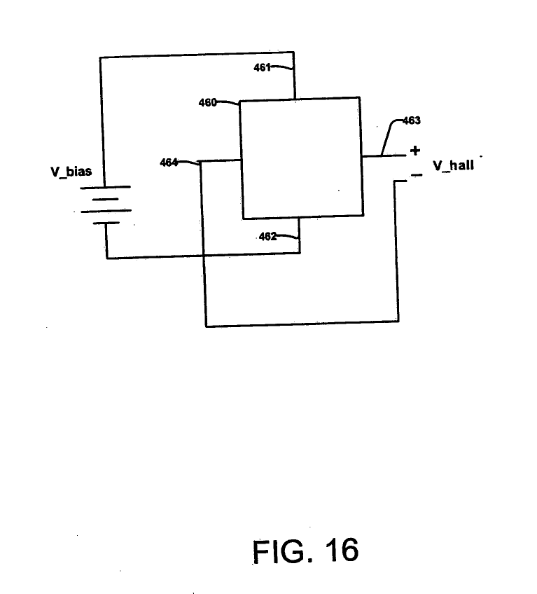

In a system that lacks the current sensing or IR sensing systems described above, a need exists to determine when resources associated with a particular television may be reallocated. Another system for making this determination is based on detecting EMF in the proximity of the particular television 104. This EMF sensing system 469 may be either tethered, as shown in FIG. 16, or physically attached to the client device 112 (or media server 108).

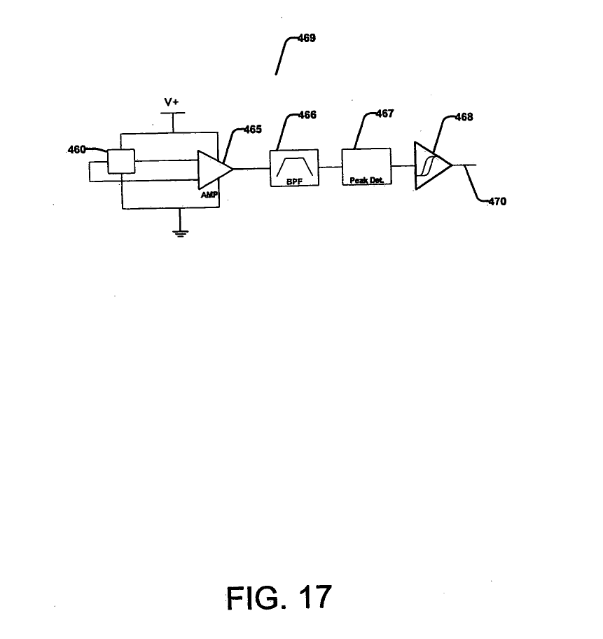

FIGS. 16 and 17 show the design and implementation of one embodiment of the EMF sensing system 469 according to this aspect of a CRM-enabled network, which performs the functionality described above. Other circuits for detecting EMF are known in the art. Thus, one can combine such an EMF sensing system 469 with the centralized resource manager and use data (ON or OFF state) from the EMF sensing system 469 to automatically reallocate network resources as applicable. Adding this EMF sensing system to other resource management schemes, such as HAVi, would also be an improvement over conventional systems.

FIG. 16 illustrates how a small sheet of semiconductor material 460 may be wired to construct a basic “Hall-Effect” sensor that is operative (as the sensing element of the EMF sensing system 469) to detect EMF emitted by the television 104 (see FIG. 15). A constant voltage source (V_bias) is placed across the sheet 460 creating a constant bias current from 461 to 462. An output voltage (V_hall) can be measured across the width of the sheet 463, 464. In the absence of a magnetic field, the voltage measured is negligible. In the presence of a magnetic field with flux lines perpendicular to the semiconductor sheet 460, the voltage across the sheet 463, 464 will be directly proportional to the strength of the magnetic field. Magnetic field sensors based on the Hall Effect are commonly available from a number of semiconductor companies including Allegro Microsystems, Analog Devices and Micronas.

Referring now to FIG. 17, the Hall-Effect sensor 460 is placed in the EMF sensing circuit 469. A typical Hall-Effect device provides a small output voltage which is amplified by amplifier 465. Band-pass filter 466 eliminates frequencies other than the primary frequency of the EMF emitted from the television set 104 based on the frame rate (59.94 Hz in the U.S.). A peak detect circuit 467 followed by a hysteresis circuit 468 provides a stable output signal 470. The threshold level of the hysteresis circuit 468 is set above the level expected in the presence of ambient EMF in the home, but well below the level expected with the circuit in situ with an operating television set. If a Schmidtt-trigger circuit is used as the final stage of the hysteresis circuit 468, output provided by the EMF sensing system 469 is a digital signal 470.

Referring now to FIGS. 15 and 17, the output of the EMF sensing circuit 469 can be sampled by a computer or embedded controller. Having this system in the STB 112 enables the system to exercise discretion with regard to several functions that should not be implemented when the television is in the ON state. For example, the software or firmware in the STB 112 can be upgraded when the television is off, instead of at an arbitrary time of day. This would ensure that the user will not be inconvenienced by such an upgrade event.

Power Switching for Automatic Resource Reallocation

Another method of determining when resources assigned to a particular TV session may be automatically reassigned is to provide a means for the user to control the power of the TV through interaction with the STB. In this embodiment the user will use a standard IR (or RF) remote control unit to signal to the STB to turn the TV on or off. By adding a power switch mechanism to the client device (or media server) the STB will then be able to add or remove power to the TV and control when it is in the ON or OFF state. With this added mechanism of control, the centralized resource manager can then determine the ON or OFF state of the television by an internal query to determine the position or state of the power switch 307. The power switch according to the present invention could be contained in the client device (or media server), or it could be contained in an external transformer power supply.

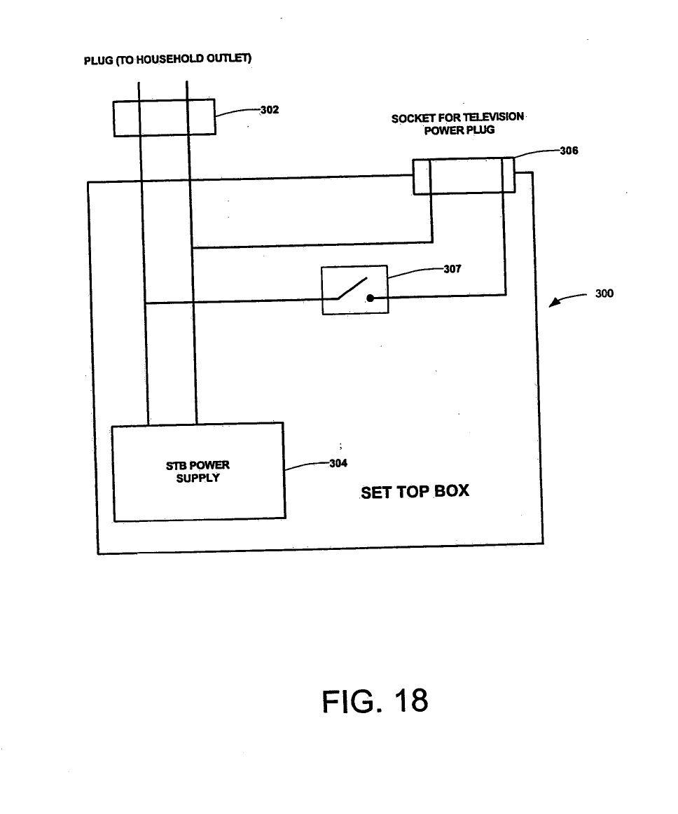

FIG. 18 shows the design and implementation of a power switch according to an embodiment of a CRM-enabled network that can perform the functionality described above. Other circuits for switching power are known in the art. Thus, one can combine such a power switch with the centralized resource manager and use the state or position of the power switch to determine the reallocation of network resources. Adding this switching mechanism to other resource management schemes, such as HAVi, would also be an improvement over conventional systems.

Referring now to FIG. 18, this aspect of a CRM-enabled network is a power switch 307 that can be used in an STB 300 or similar client device to control the turning on and turning off of the television which powered through the STB 300. The STB 300 is connected to the AC power (in the United States, typically 110 volts AC) by means of a standard power cord plug 302. The STB 300 includes a power supply 304. A connection is made from this power source 304 to an outlet 306 on the STB 300 to which the television power cord is connected. Thus, the television will draw its current through this connection in the STB 300. One of the power conductors going to the outlet is passed through a power switch 307, allowing the circuit shown in FIG. 18 to control the voltage and thus control whether the television is in the ON or OFF state.

Referring to FIG. 18, the ‘state’ of the power switch 307 can be controlled by and sampled by a computer or embedded controller which is capable of communicating with the centralized resource manager. Thus, the centralized resource manager can effectively control the allocation of the resources of the television after determining whether the television is in the ON or OFF state via a ‘state’ query directed the power switch 307.

Description of Exemplary Embodiments of CRM Functionality

The functionality of the CRM as a manager exercising central control over resources in a HAN can be illustrated through a discussion of example embodiments. Other embodiments within the scope of the present invention will be apparent to those skilled in the art in light of the present disclosure.

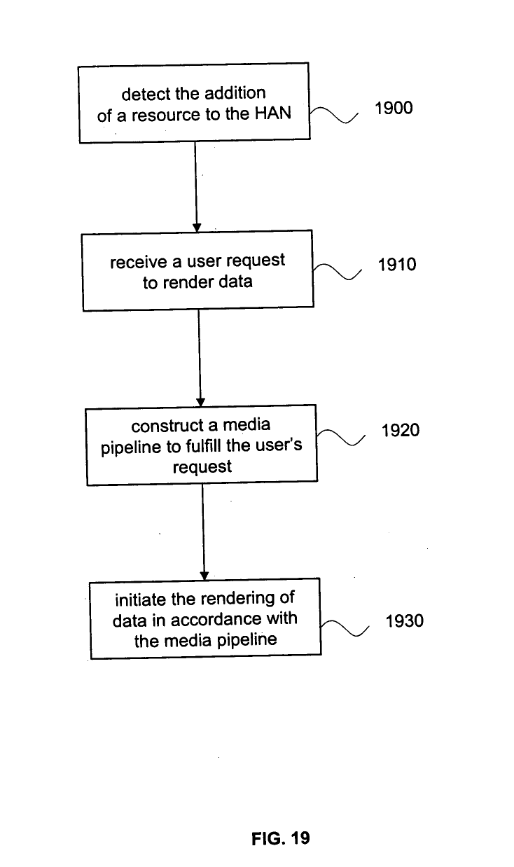

FIG. 19 illustrates a method for practicing an embodiment of the present invention. A CRM in a HAN may execute the steps disclosed in this figure in the example embodiment. In step 1900 of the embodiment of FIG. 19, the CRM detects the addition of a resource to the HAN. The CRM may do this automatically—e.g., without any programming activity on the part of the user or in a manner such that the only required user action is to connect the resource to the HAN—for example by detecting a signal generated by the newly connected resource and transmitted on the HAN. In another embodiment, the CRM may periodically transmit resource-query messages on the HAN requesting resources connected to the HAN to identify themselves. When a resource newly added to the HAN receives such a message, it may reply and thus cause the CRM to detect it. The CRM may, among other things, implement an auto-discovery protocol such as Simple Service Discovery Protocol. Other methods of detection of a newly added resource by a CRM will be apparent to those skilled in the art in light of the present disclosure.

In step 1910 of the embodiment depicted in FIG. 19, the CRM receives a user request to render data on the HAN. For example, the user may request that a program from an electronic program guide be rendered on a selected display device of the HAN at a predetermined time or for a specified future time period. Alternatively, the user may request that a program or other media data be streamed to a particular display device in real-time. The user may transmit such a user request by using a remote control, or by otherwise programming a resource on the HAN. In embodiments, the CRM receives the user request by virtue of the fact that it is connected directly, or indirectly through one or more other resources, to the resources of the HAN.

Generally, the destination resource associated with a user request may not be limited to a display device. For example, the user may request that a program being broadcast by a service provider be recorded to memory resource 2210. Additionally, a user request may not directly specify the recording or playback of a specific program at a specific time. For example, the user may request that all James Bond movie-content be recorded. Media server 2270 may determine based on information from a newly updated electronic program guide that “Thunderball” will be played on a specific cable channel at 9 pm. Based on this, media server 2270 may request that CRM 2280 construct and implement a media pipeline resulting in the recording of “Thunderball” from that cable channel at that time.

The term “user request” as used herein may also include generalized system requests that are not directly related to a request from a particular user. In an embodiment, media server 2270 may implement logic that results in a request to the CRM to record all advertisements on a specific channel during a non-peak period. Such advertisements may be stored in memory, e.g., memory 2210, for playback or storage in connection with programs of interest to members of the household of the HAN. Such requests are also “user requests” as used in the present disclosure.

In step 1920 of the embodiment depicted in FIG. 19, the CRM constructs a media pipeline to fulfill the user's request. In embodiments, the CRM may do this by checking a reservations database to determine the resources available on the HAN that could be used to fulfill the user's request. If, among the available resources that may be used to construct the media pipeline, more than one resource of the same type is available (e.g., two tuners are available for constructing a media pipeline requiring a tuner), then the CRM may determine which resource of that type to use in the media pipeline through a resource protocol or least-cost algorithm, as discussed earlier. In embodiments, the least-cost algorithm may include a comparison of the HAN bandwidth consumed by candidate media pipelines, each of which contains a representation of one of the candidate resources. For example, where there are two candidate tuners that may be used in the media pipeline to satisfy a particular user request, the HAN bandwidth that would be consumed by the media pipeline containing a representation of the first candidate tuner may be compared with the HAN bandwidth consumed by the media pipeline containing a representation of the second candidate tuner. In an embodiment in which the minimization of consumed HAN bandwidth is the determining criterion, the candidate tuner of the media pipeline consuming less bandwidth could then be selected for actual inclusion in the media pipeline. Other algorithms for identifying sets of resources for inclusion in a media pipeline for fulfilling user requests will be apparent to those skilled in the art in light of the present disclosure.

An example of the embodiment described directly above is illustrative. In this example, the user request may involve the streaming of a 4 Mbps program from one of two HAN tuners to a particular display device. Moreover, the user request may include the ability to use live-pause DVR functionality in viewing the program. Thus, a HAN resource with buffering functionality—e.g., a drive—may be required to fulfill the user request. Assuming that the display device and the sole drive in the HAN are located in differing rooms, and that one tuner is local to the display device while the other tuner is local to the drive, the CRM in the present embodiment may use the tuner that is local to the drive, because data flowing from the tuner would then travel a shorter distance than would be the case if the other tuner were used. In other words, network bandwidth consumption would be reduced, because media data from the tune local to the display would need to traverse the network twice (once from the display to the disk, and once from the disk to the display, while a media data stream from a tuner local to the drive would only traverse the network once (from the drive to the display). In this manner, network bandwidth consumption would be reduced.

More generally, if there are two types of resources that could be used in a media pipeline to fulfill the user's request, and there is more that one resource available for each type, then an available resource of the first type and an available resource of the second type can be selected so that the resulting media pipeline consumes the least amount of HAN bandwidth (e.g., by considering the media pipelines and corresponding HAN bandwidth consumption resulting from each combination of the available resources of the first and second types). It is convenient to label a resource that is upstream in terms of the data flow direction in a media pipeline as a “source resource” and to label a resource that is downstream of the source resource as a “destination resource.”

In embodiments where the user's request involves an event (such as playback of a program or recording of a program) at a future time or time interval, the set of available resources for fulfilling the user's request may be determined from the resources available at that time or time interval, as indicated by pre-existing entries in a reservations database that can be accessed by the CRM. Further, once a media pipeline to fulfill the user's request is constructed, the CRM may store a representation of that time or time interval (i.e., a time-usage indication) in association with a representation of the media pipeline in the reservations database. In embodiments where the user's request involves a real-time event (such as immediate playback of a program), then the available resources for fulfilling the user's request are determined at that time based on pre-existing entries in the reservations database. Because the length of time of use of the resources in the corresponding media pipeline may be uncertain for a real-time event, the time-usage indication stored in association with the representation of the media pipeline in this case may indicate, instead of a particular time or time interval, a flag representing indefinite usage of the resources used for the media pipeline. The CRM may then consider these resources to be unavailable for other uses until it detects or otherwise decides that such real-time us of the resources has terminated. However, regardless of whether the user request involves a future event or a real-time current event, the CRM may construct the media pipeline for fulfilling the user request as discussed above (e.g., based on bandwidth considerations as discussed earlier).

In the embodiment depicted in FIG. 19, the CRM at step 1930 initiates the rendering of media data in accordance with the constructed media pipeline and the associated time-usage indication.

In embodiments, a user request for a live session (i.e., real-time playback) may be treated by the CRM as having a lower priority compared to pre-scheduled media pipelines. For example, if a user requests a live session, and the CRM determines that fulfilling the user request will conflict with a media pipeline represented in the reservations database, the CRM may direct the display device to display a message warning the user about the conflict and asking the user to confirm that the conflicting media pipeline will overridden. If the user provides such confirmation by user input through, e.g., the display device and the user's remote control, then in these embodiments the CRM will delete the representation of the conflicting media pipeline from the reservations database, freeing the HAN resources represented in the conflicting media pipeline.

In embodiments, a user request for a live session may result in the CRM implementing a live session media pipeline that utilizes one or more HAN resources that are also represented in media pipelines of the reservations database that are scheduled for implementation in the future. At the time of or shortly before these resources are scheduled to be used in an implementation of such a pre-existing media pipeline, the CRM may provide the user with a warning and the option of terminating the pre-existing media pipeline. In these embodiments, if no response is obtained from the user within a predetermined time, the CRM may assume that the user is no longer watching the live session and may terminate it, freeing up the resources for implementation of the conflicting pre-existing media pipeline. Thus, in these embodiments, the CRM treats live sessions as having lower priority compared to pre-existing media pipelines represented in the reservations database.

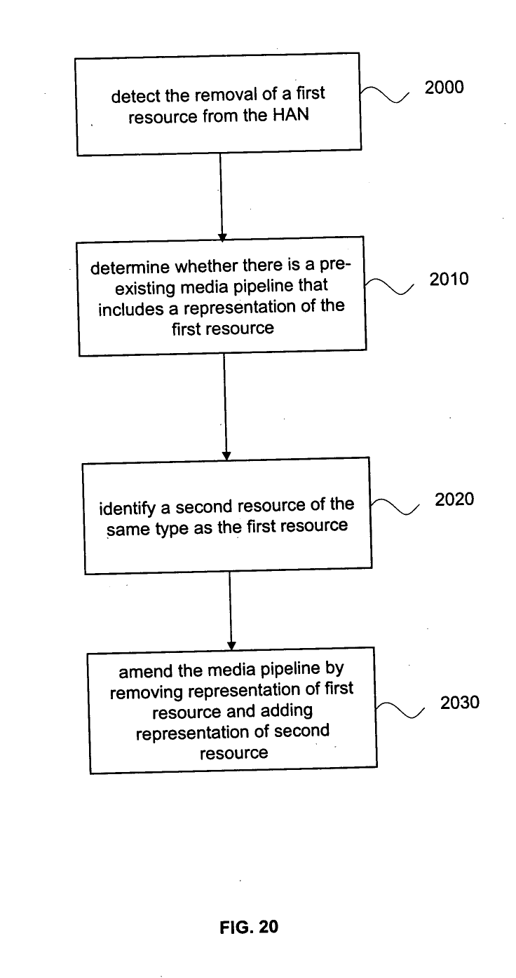

FIG. 20 illustrates another embodiment exemplifying CRM functionality. In this embodiment, the CRM detects the removal of a resource from the HAN and subsequently checks whether any media pipelines represented in a reservations database include representations of the removed resource. If one or more media pipelines include a representation of the removed resource, then in embodiments those media pipelines are reconstructed with resources that remain available in the HAN.

The embodiment depicted in FIG. 20 begins with step 2000 in which the CRM detects the removal of a first resource from the HAN. One possibility is that the first resource is physically removed from the HAN—e.g., the device including or implementing the resource is physically removed or its power connection is disconnected. Alternatively, a user may override pre-existing entries in the reservations database by, for example, requesting a real-time streaming event requiring a number of resources that are unavailable at the relevant time a reflected in the pre-existing entries in the reservations database. The CRM may also detect the removal of the resource, by for example, periodically querying resources on the HAN and not receiving an acknowledgment message back from the removed resource, or by detecting a user override command removing the resource from availability to implement pre-existing media pipelines referenced in the reservations database.

In step 2010 of the embodiment depicted in FIG. 20, the CRM determines whether there is a pre-existing media pipeline in the reservations database that includes a representation of the first resource that has been removed from the HAN. The CRM may do this, for example, by checking each pre-existing media pipeline and determining whether any contain a representation of the removed resource.

In step 2020, the CRM identifies a second resource in the HAN that may be used instead of the removed resource in media pipelines represented in the reservations database. For example, the CRM may check the reservations database to determine whether any resources of the same type as the removed resource are available at the time(s) indicated by the time-usage indication stored in the reservations database in association with a media pipeline containing a representation of the removed resource. Such a resource found by the CRM may be used to replace the resource removed from the HAN. If more than one such resource is identified, then the CRM may determine the replacement resource that is to be actually used by an algorithm as discussed earlier. In one embodiment, if no replacement resource is identified, then a message may be displayed to the user indicating the occurrence of an error, and the relevant media pipeline may be abandoned and deleted from the reservations database.

In step 2030 of the embodiment depicted in FIG. 20, the CRM amends the relevant media pipeline by removing the representation of the first resource and adding a representation of the second resource. In embodiments, the time-usage indication associated with the media pipeline remains unchanged.

In embodiments, the CRM may not perform at least one of steps 2010, 2020 and 2030 until after some time elapses following step 2000. This may be done in these embodiments to avoid the needless reallocation of resources where the first resource is only temporarily removed from the HAN—e.g., where the first resource needs to be shut down and rebooted. In one aspect of these embodiments, the CRM may not carry out steps 2010, 2020 and/or 2030 until after a pre-determined amount of time elapses after the CRM detects the removal of the first resource. In another aspect of these embodiments, the CRM may not carry out steps 2020 and/or 2030 until a time shortly before a pre-existing media pipeline containing a representation of the removed first resource is scheduled to be implemented. In yet another aspect of these embodiments, the CRM may not carry out steps 2010, 2020 and/or 2030 until after an explicit message is received from the first resource that it is leaving the HAN.

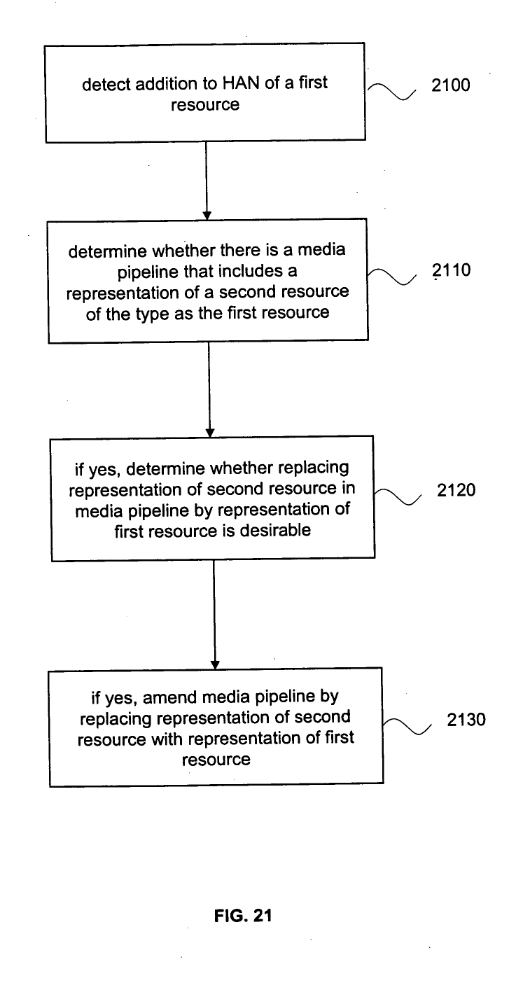

FIG. 21 illustrates another embodiment of the present invention exemplifying CRM functionality. In this embodiment, a CRM detects the addition of a resource to the HAN, and subsequently checks whether any media pipelines represented in the reservations database include representations of resources of the same type as the added resource. In this embodiment, if such a media pipeline exists, the CRM determines whether it is desirable to replace the representation of the existing resource of the same type in that media pipeline with a representation of the added resource. In this embodiment, if the CRM determines that such replacement is desirable (for example, because the replacement will utilize less bandwidth), the CRM may amend or reconfigure that media pipeline by removing the representation of the existing resource of the same type and adding a representation of the added resource.

In step 2100 of the embodiment depicted in FIG. 20, the CRM detects the addition to the HAN of a new resource. The CRM may detect the new resource as described earlier in connection with FIG. 19.

In step 2110, the CRM determines whether the reservations database includes a representation of a media pipeline that includes a representation of a pre-existing resource of the same type as the new resource. For example, if the new resource is a tuner, the CRM may determine whether any pre-existing media pipelines represented in the reservations database contain representations of pre-existing tuners in the HAN.

In step 2120, the CRM determines whether it would be desirable to amend or reconfigure any media pipeline identified in step 2110 so that the pre-existing resource is replaced with the new resource for that media pipeline. The CRM may determine whether such amendment or reconfiguration is desirable by, for example, using an algorithm as described earlier to compare a media pipeline that includes a representation of a pre-existing resource with one including a representation of the new resource. Such an algorithm may be based on one or more pre-determined selection criteria that are programmed into the hardware and/or software logic implementing the CRM.

If the CRM determines in step 2130 that replacement would be desirable, then the CRM in step 2130 of the embodiment depicted in FIG. 21 amends the representation of the relevant media pipeline in the reservations database by removing the representation of the pre-existing resource and adding a representation of the new resource. In such an embodiment, when the media pipeline is actually established, then, in accordance with the amended representation in the reservations database, the new resource would be used in place of the pre-existing resource.

It is illustrative to consider another example of the embodiment discussed in connection with FIG. 21. In this example, the reservations database of the CRM contains a representation of a media pipeline for implementing a live-pause session. The media pipeline may represent the streaming of data from a tuner local to a display device to a storage disk located in another room, and playback from the storage disk to the display device. In the example, the user adds a second tuner local to the storage disk (e.g., the user may connect the second tuner using a USB interface to a server or local resource manager that is local to the storage disk). In this example, the CRM may determine that it should replace the representation of the pre-existing tuner with a representation of the second tuner in the media pipeline, because this will result in a lower cost network due to the shorter distance media data will need to travel through use of the second tuner instead of the pre-existing tuner.

Interactions of a CRM with other CRMs in a HAN

In some embodiments of the present invention, a CRM may have the capability to detect the addition to the HAN of another resource that is also capable of CRM functionality. Either or both CRMs may also have the ability to negotiate and agree with one another regarding which CRM is to provide centralized control over HAN resources, and which CRM is to operate in a manner that does not conflict with the other CRM's centralized control. In embodiments, such detection and/or negotiation may take place in accordance with a pre-defined protocol implementing logic programmed into the software unit and/or the hardware device implementing CRM functionality. Each CRM may be capable of implementing any or any combination of the CRM features discussed above. Thus, embodiments of the present invention include a CRM that has the capability to implement any or any combination of the CRM features discussed above, and that is further capable of detecting and negotiating with, when present, another CRM in the HAN that also has the capability to implement any or any combination of the discussed CRM features.

Overview of Unmanaged Device Support in a Home Area Network

In some situations, a Home Area Network may include a CRM, a first set of one or more resources that are capable of being controlled by the CRM, and a second set of one or more resources that are not capable of being controlled by the CRM. The first set of resources and the CRM may employ a first control protocol that allows the CRM to communicate with and control these resources, whereas the second set of resources may implement a second control protocol for resource control and communication that is not compatible with the first control protocol. Commands and statements in the first control protocol, for example, allow the CRM to carry out the functionality described earlier—e.g., the CRM may implement a media pipeline that includes a resource from the first set by communicating with that resource using the first control protocol. Such communications using the first control protocol may include, for example, control commands and/or query commands that allow the CRM to cause a resource from the first set (i.e., a “CRM-aware resource”) to carry out the functionality corresponding to its representation in a media pipeline constructed by the CRM. For example, a first control protocol command issued by the CRM may indirectly cause a CRM-aware tuner that is represented in a media pipeline to tune into a program associated with the media pipeline and provide output to the next resource indicated in that media pipeline. (For example, the CRM may provide a representation of the relevant media pipeline to an application or application service that contains a pointer to the assigned resource. The application or application service may then cause the resource to perform its functionality through use of the pointer.) Similarly, first control protocol commands issued by the CRM may cause the other resources represented in the media pipeline to carry out the functionality indicated by that media pipeline.

In contrast, commands of the second protocol are not capable of allowing a CRM to either construct or implement a media pipeline that involves a resource in the second set. The second protocol may, for example, be a previously known resource discovery with a control protocol such as UPnP, Jini, HAVi or any other resource discovery and control protocol known to those with skill in the art. Such protocols do not allow CRM-like centralized control of other resources in the HAN, and in particular, do not allow a CRM to either construct or implement a media pipeline including a non-CRM aware resource. In this sense, the first protocol and the second protocol are not compatible with one another. It may be possible, however, that the first protocol and the second protocol, although incompatible with one another in this sense, share some common functionality—for example, in some implementations, both may use Simple Service Discovery Protocol commands or concepts to provide device discovery in the Home Area Network.

Home Area Network with CRM and Unmanaged Devices

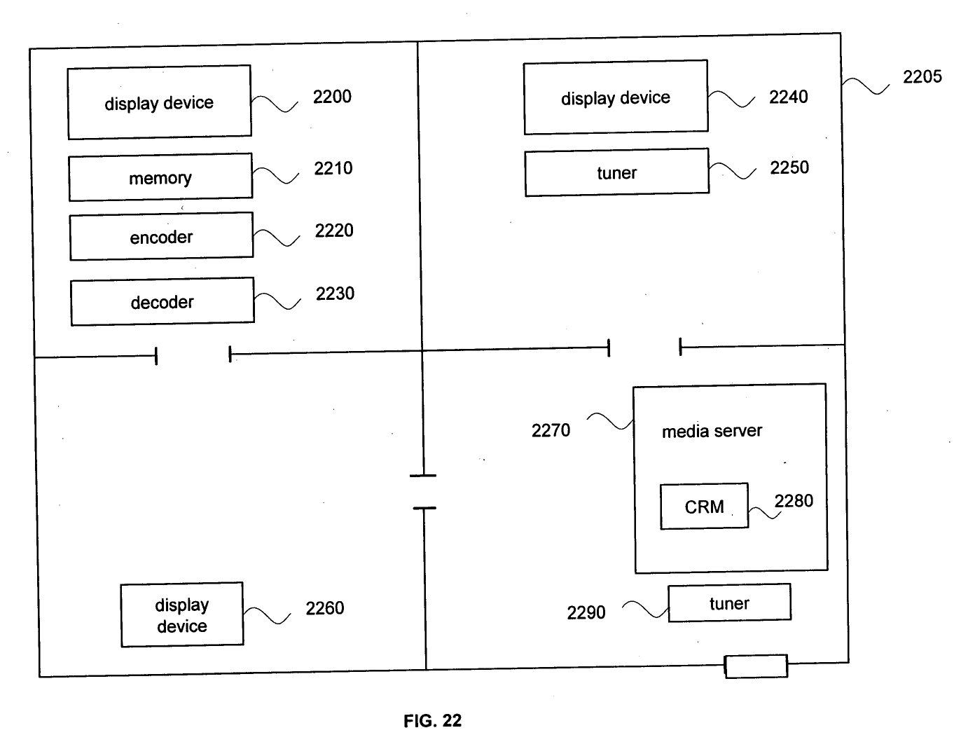

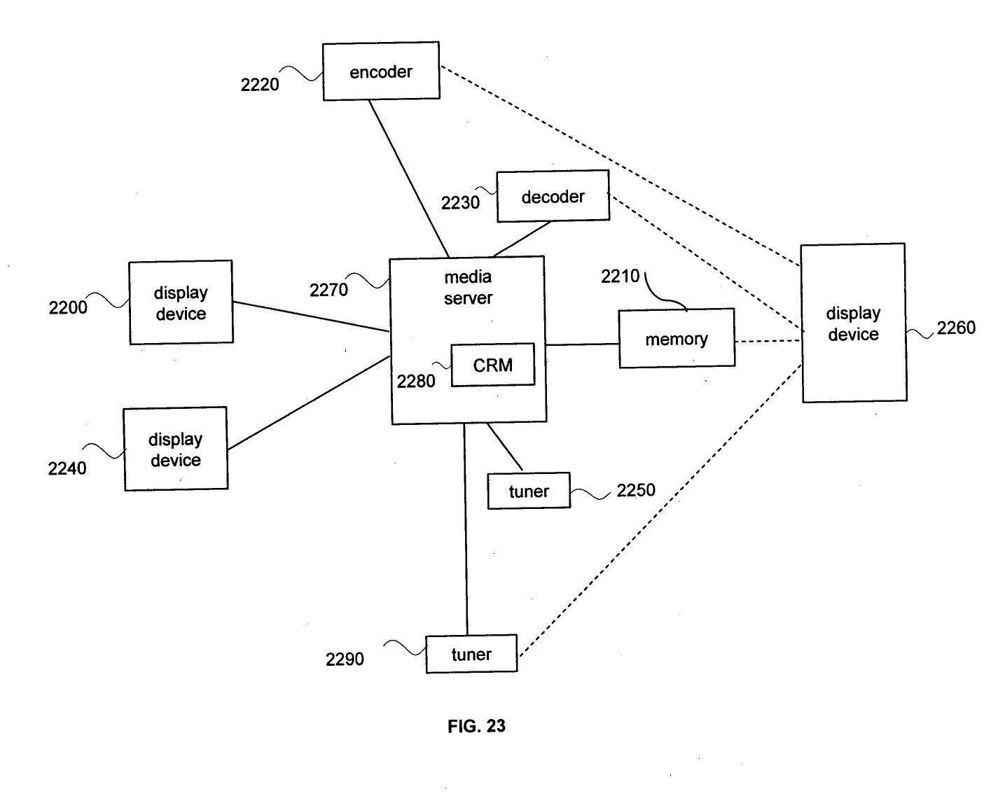

FIGS. 22 and 23 illustrate an example of a Home Area Network that includes a CRM, at least one CRM-aware resource and at least one non-CRM aware resource. FIG. 22 shows the layout of an example HAN in customer premises 2205, which, in this example, comprises four rooms. Display device 2200, memory 2210, encoder 2220 and decoder 2230 are located in a first room of customer premises 2205; display device 2240 and tuner 2250 are located in a second room of customer premises 2205; display device 2260 is located in a third room of customer premises 2205; and tuner 2290 and media server 2270 are located in a fourth room of customer premises 2205. Additionally, FIG. 22 indicates that in this example, media server 2270 includes CRM 2280.

One or more of the resources illustrated in FIG. 22 may be connected to a set-top box providing known local resource management functionality. Such set-top box functionality associated with a resource of the HAN may alternatively be implemented within the resource itself, as will be apparent to one skilled in the art based on this disclosure.

In embodiments, display devices 2200, 2240 and 2260 may each have a local decoder resource (not shown) that is utilized, for example, for decoding MPEG2 (or other MPEG) encoded data. Such a decoder may be a part of a display device, or in an alternative embodiment, may be implemented in a set-top box local to a display device. Moreover, media server 2270 may have a local memory or other storage resource (not shown). Additionally, tuners that are utilized in embodiments of the invention include analog tuners as well as digital tuners. An analog tuner in embodiments of the invention may additionally include an MPEG2 (or other MPEG) encoder (not shown). A tuner in embodiments of the invention may be used to tune to a carrier in the relevant medium in which the media data propagates to the tuner. The tuner may then demodulate media data modulated onto the carrier to extract useful data. Demodulation functionality may be implemented in the tuner resource itself, or an additional demodulator resource may be used in conjunction with the tuner for such functionality. All such embodiments will be apparent to one skilled in the art based on the present disclosure.

FIG. 23 illustrates the HAN of FIG. 22 in greater detail. Among other things, FIG. 23 depicts a HAN in which display device 2200, display device 2240, tuner 2250, tuner 2290, memory 2210, encoder 2220, decoder 2230 are CRM-aware resources, and in which display device 2260 is a non-CRM aware resource. In this example, CRM 2280 implements a first control protocol for controlling the CRM-aware resources. Among other things and as discussed earlier in this disclosure, CRM 2280 manages user requests involving the CRM-aware resources, constructs and implements media pipelines involving these resources (based, for example, on HAN bandwidth consumption considerations as discussed earlier) to fulfill the user request and maintains a reservations database containing representations of media pipelines for implementation as well as corresponding time-usage indications relating to the timing of such implementation.

In the embodiment depicted in FIG. 23, display device 2260 is a non-CRM aware resource that implements or is responsive to a second control protocol that is not compatible with the first control protocol. Encoder 2220, decoder 2230, memory 2210, and tuner 2290 are CRM-aware resources that additionally implement or respond to the second control protocol; i.e., they are dually enabled resources. The dotted connecting lines shown in FIG. 23 are connected to resources that are capable of responding to or implementing the second control protocol and are not otherwise CRM-aware, whereas the solid connecting lines are connected to resources that are CRM-aware and that are hence capable of implementing the first control protocol.

The example shown in FIG. 23 is merely illustrative; in general, there may be any number of non-CRM aware resources such as display device 2260 in the HAN. Similarly, there may be any number of CRM-aware resources in a HAN. Moreover, CRM 2280 may be located in a physical unit that is distinct from the physical unit in which media server 2270 is located. Additionally, the CRM-aware resources in the HAN may not be directly connected to media server 2270 and/or CRM 2280, but may instead be connected to either or both of these indirectly through one or more other resources (e.g., in accordance with known network topologies such as a bus, ring or tree topology). All of these and other variations apparent to those skilled in the art are within the scope of the present invention in light of this disclosure.

In the embodiments of the invention discussed in this section of the present disclosure, a CRM-aware resource that implements both the CRM-compatible first control protocol and a second control protocol not compatible with the first control protocol (e.g., any of encoder 2220, decoder 2230, memory 2210 and tuner 2290 in the example of FIG. 23), and receives a request for the provision of services from a non-CRM aware resource (e.g., display device 2260 in the example of FIG. 23).

In an embodiment, this dually enabled resource transmits a message to the CRM requesting permission from the CRM to provide the service requested by the non-CRM resource. The CRM determines, based on the reservations database, whether the dually enabled resource is otherwise scheduled to be used within the sub-network of the HAN defined by the CRM-aware resources. If the CRM determines that the provision of the requested service by the dually enabled resource to the non-CRM aware resource will not conflict with pre-existing entries in the reservations database, then the CRM transmits a permission message to the dually enabled resource for the provision of the requested service. If the CRM determines that the provision of the service will conflict with the pre-existing entries in the database, then the CRM either does not reply (implicitly indicating denial of permission), or otherwise indicates its denial of permission by sending an explicit denial message to the dually enabled device. The dually enabled device, in this embodiment, will provide the requested service to the non-CRM enabled device only if it receives an explicit permission message from the CRM.

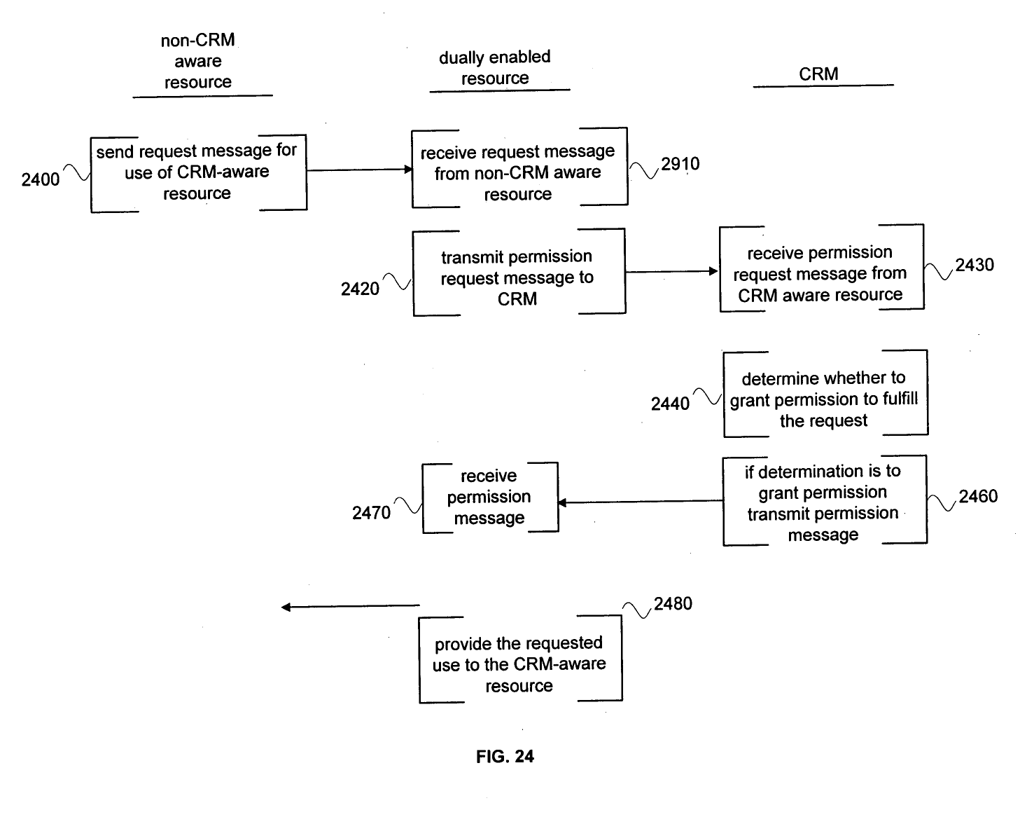

FIG. 24 illustrates this embodiment of the present invention summarized directly above. In step 2400, a non-CRM enabled resource in the HAN sends a message to a dually enabled resource requesting that that the latter provide a service. For example, display device 2260 may transmit such a request message to tuner 2290. Such a request message could, for example, in turn be prompted by user input through a remote control unit requesting the streaming of a program or other real-time media data to display device 2260. In one aspect of this embodiment, the request message is formatted according to the rules of the second control protocol.

In step 2420 of the embodiment depicted in FIG. 24, the dually enabled resource receives the request message, and in response to this, in step 2420 transmits a permission request message, or a notification message implicitly requesting such permission, to the CRM for permission to provide the requested service to the non-CRM aware resource. In the aspect of the embodiment currently being discussed, the permission request message (or the notification message) may be formatted according to the rules of the first control protocol.

In step 2430, the CRM receives the permission request message (or the notification message) from the dually enabled resource. In response to this, the CRM in step 2440 determines whether to grant permission to the dually enabled resource to provide the requested service to the non-CRM aware resource. The CRM's decision as to whether to grant permission may be based on the request and pre-existing entries in the reservations database of the CRM. For example, the CRM may search the reservations database for pre-existing entries that would conflict with the provision of the requested service by the dually enabled resource to the non-CRM aware resource. If a conflict is determined to exist, than the CRM may not provide permission for the dually enabled resource to provide the service to the non-CRM aware resource. If no conflict is identified, then the CRM may determine to provide permission to the dually enabled resource.

In an aspect of this embodiment, the CRM may search the reservations database for any pre-existing entry comprising a media pipeline that contains a representation of the dually enabled resource and an associated time-usage indication that indicates a potential conflict with the request from the non-CRM aware resource. Where the request from the non-CRM aware resource is for the provision of a future service, the request message of steps 2400 and 2410 may indicate the timing requirements for that service. Similarly, the permission request message (or notification message) of steps 2420 and 2430 may also include this timing requirement information. The CRM may then, for any media pipeline stored on the reservations database that includes a representation of the dually enabled resource, compare the timing requirement information of the request from the non-CRM aware resource with the time-usage indication associated with that media pipeline. The CRM may determine based on this comparison whether a conflict arises from the provision of the service by the dually enabled resource to the non-CRM aware resource.

In this aspect of the embodiment, where both the timing requirement information and time-usage indication are time intervals, the CRM may determine that a conflict exists when these two intervals overlap. Where the request from the non-CRM aware resource is for the provision of an immediate or real-time service, the CRM may determine that a conflict exists, for example, when a pre-existing media pipeline that is represented in the reservations database (and that contains a representation of the dually enabled resource) is associated with a time-usage indication that indicates reservation of the dually enabled resource at a time that is within a predetermined period of the requested immediate use. The CRM in this way may determine in this aspect of the embodiment whether a conflict would arise from the provision of the service by the dually enabled resource to the non-CRM enabled resource.

If the CRM determines in step 2440 to grant permission to the dually enabled resource to provide the service to the non-CRM aware resource, then the CRM in step 2460 transmits a permission message to the dually enabled resource.

The dually enabled resource at step 2470 receives the permission message transmitted by the CRM at step 2460. In response to this message, the dually enabled resource at step 2480 initiates provision of the requested service to the non-CRM aware resource at a time indicated in or based on the timing requirement information.

The CRM may optionally enter an indication in the reservations database indicating that the dually enabled resource is or will be busy at a time or during a time interval indicated by the timing requirement information. Alternatively, the CRM may not make such an entry and treat subsequent requests from CRM-aware resources in the HAN for services from the dually enabled resource as having a greater priority than the request made by the non-CRM aware resource. In this alternative aspect, the CRM, after receiving a request from a CRM-aware resource for the provision of a service by the dually enabled resource that conflicts with the service being provided to or scheduled to be provided to the non-CRM aware device, transmits a revocation message to the dually enabled device revoking the prior permission. The dually enabled resource may subsequently terminate the provision of the service to the non-CRM enabled resource, or if such service was scheduled for a future time, may not initiate the provision of that service at the future time.

In another embodiment of the present invention, the dually enabled resource provides the service requested by the non-CRM aware resource without waiting for any permission from the CRM, and transmits a notification message to the CRM regarding its provision of the service to the non-CRM aware resource. If the CRM subsequently determines that a conflict exists between pre-existing entries in the reservations database and the provision of the service to the non-CRM aware resource, then the CRM transmits a termination message to the dually enabled resource directing the dually enabled resource to terminate the provision of the service to the non-CRM aware resource. The dually enabled resource receives this termination message and subsequently terminates the provision of the service to the non-CRM aware resource.

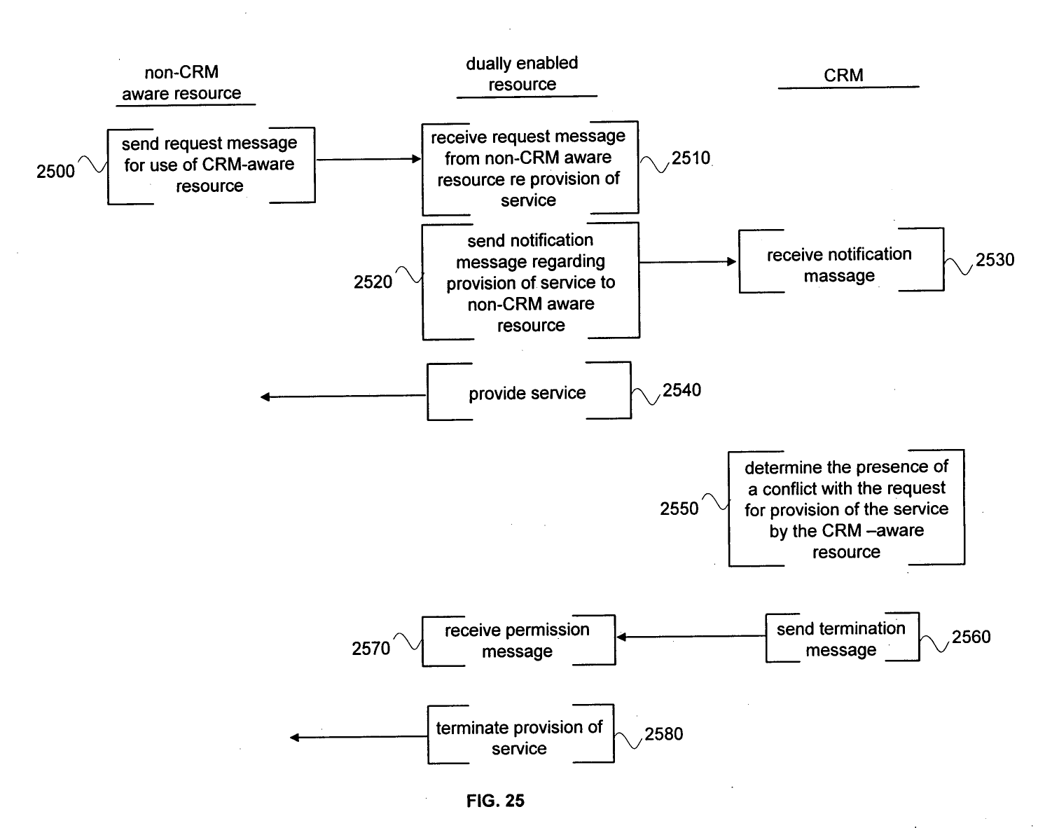

FIG. 25 illustrates the second embodiment discussed directly above. In step 2500, a non-CRM aware resource in the HAN sends a message to a dually enabled resource requesting that that the latter provide a service.

In step 2510 of the embodiment depicted in FIG. 25, the dually enabled resource receives the request message, and in response to this, in step 2520, transmits a notification message to the CRM notifying the CRM that it has initiated the provision of the service or that it will provide the service in the future. The dually enabled resource may include timing requirement information in the notification message relating to the time at which the non-CRM aware device requests that the service be provided, similar to the description of how timing requirement information may be included in the permission message of the first embodiment discussed above.

In the embodiment depicted in FIG. 25, the dually enabled resource in step 2540 initiates the provision of the requested service to the non-CRM aware resource. As will be apparent to those skilled in the art based on the present disclosure, step 2540 may be carried out before, after or at the same time as step 2520.

As depicted in FIG. 25, the CRM in step 2530 receives the notification message transmitted by the dually enabled resource at step 2520. The CRM may make an entry in the reservations database indicating that the dually enabled resource will be busy at a time indicated by any timing requirement information that is received with the notification message.

The CRM may determine at step 2550 that a conflict exists or arose in the reservations database among entries relating to the dually enabled resource. The CRM may determine such a conflict exists, for example, based on the timing requirement information relating to the request of the non-CRM aware resource and the time-usage indication associated with a media pipeline that is represented in the reservations database and that includes a representation of the dually enabled resource. It will be apparent to those skilled in the art, based on the disclosure in connection with the embodiment discussed above with reference to FIG. 24 how a CRM may be configured to implement such conflict determination.

If the CRM does not determine the presence of any conflict, then the CRM, in one aspect of the second embodiment, will not intervene and will allow the dually enabled resource to provide the service to the non-CRM aware resource. If, on the other hand, in the embodiment depicted in FIG. 25, the CRM at step 2550 determines the presence of a conflict, then the CRM at step 2560 transmits a termination message to the dually enabled resource directing the latter to terminate the provision of the service to the non-CRM aware resource. Alternatively, where the request of the non-CRM aware resource relates to a future service to be provided by the dually enabled resource, the termination message may direct the dually enabled resource to not initiate the provision of the service to the non-CRM aware resource.

In step 2580, the dually enabled resource terminates provision of the service to the non-CRM aware resource. Alternatively, where the request of the non-CRM aware resource relates to a future service to be provided by the dually enabled resource, the dually enabled resource does not initiate the provision of the service to the non-CRM aware resource.

In another embodiment, the dually enabled resource provides the service requested by the non-CRM aware resource without waiting for any permission from the CRM and without providing any notification to the CRM. However, if the dually enabled resource subsequently receives a request from the CRM to provide a service to a CRM-aware resource that conflicts with the provision of the service to the non-CRM aware device, then the dually enabled resource terminates provision of the service to the non-CRM aware resource and initiates provision of a service to the CRM-aware resource.

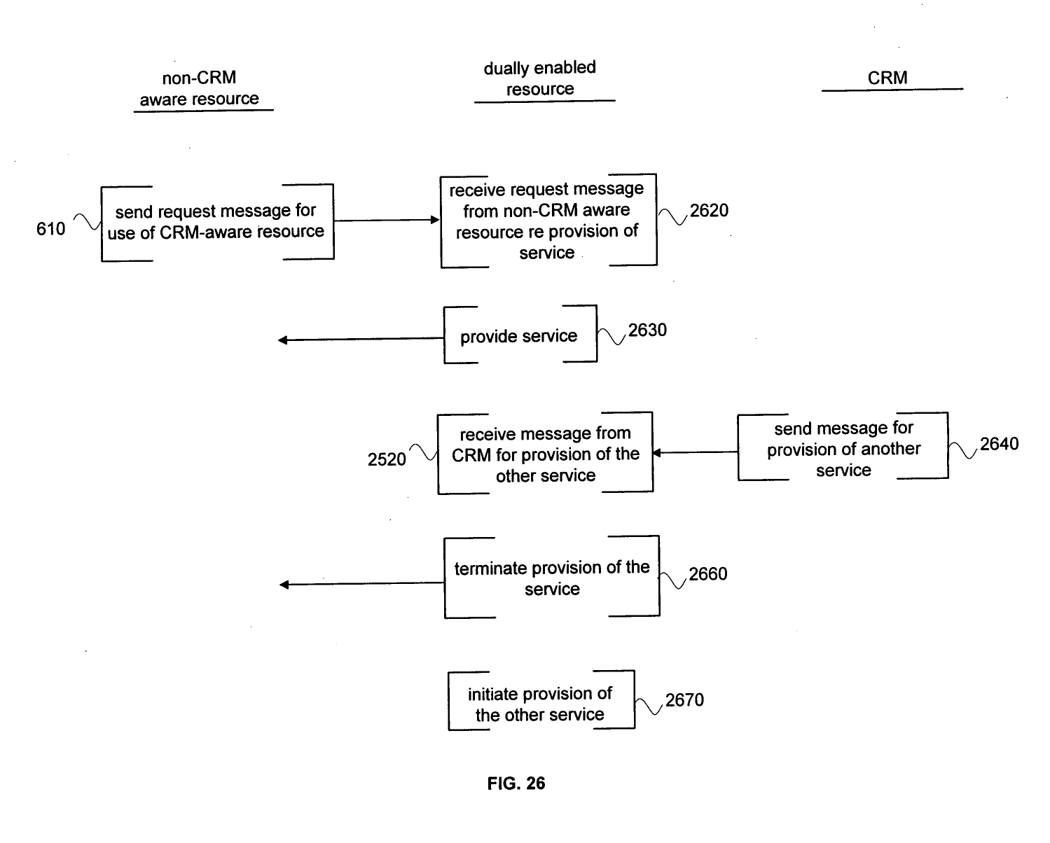

FIG. 26 illustrates this embodiment summarized directly above. In step 2610, a non-CRM enabled resource in the HAN sends a message to a dually enabled resource requesting that that the latter provide a service.

In step 2620 of the embodiment depicted in FIG. 26, the dually enabled resource receives the request message, and in response to this, in step 2630, initiates provision of the service to the non-CRM aware resource.

In step 2640, the CRM transmits a message to the dually enabled resource directing the latter to provide a different service to a CRM-aware resource of the HAN.

In step 2650, the dually enabled resource receives the message of the CRM of step 2640. In response to this, the dually enabled resource in step 2660 terminates provision of the service to the non-CRM aware resource. The dually enabled resource in step 2670 subsequently initiates the provision of the different service to the CRM-aware resource.

The embodiments discussed above in connection with FIGS. 24-26 illustrate CRM functionality relating to the regulation of the usage of resources of the HAN. Other embodiments within the scope of the present invention will be apparent to those skilled in the art based on the disclosure above.

A Dually Enabled CRM

In embodiments, a CRM may implement both a first control protocol and a second protocol. In these embodiments, the CRM may use the first control protocol to establish and implement central control over CRM-aware resources as described in the embodiments discussed above. For example, the CRM may use the first control protocol to communicate with CRM-aware resources in the construction of media pipelines to fulfill user requests based on a least cost algorithm relating to a characteristic HAN parameter such as HAN bandwidth. The second control protocol, on the other hand, may be any of the known network control protocols such as UPnP, Jini and HAVi. For example, the CRM, by using the second control protocol—e.g., UPnP—may act as a UPnP control point for treating and controlling non-CRM aware resources on the HAN as UPnP servers and UPnP renderers, as will be: apparent to those skilled in the art.

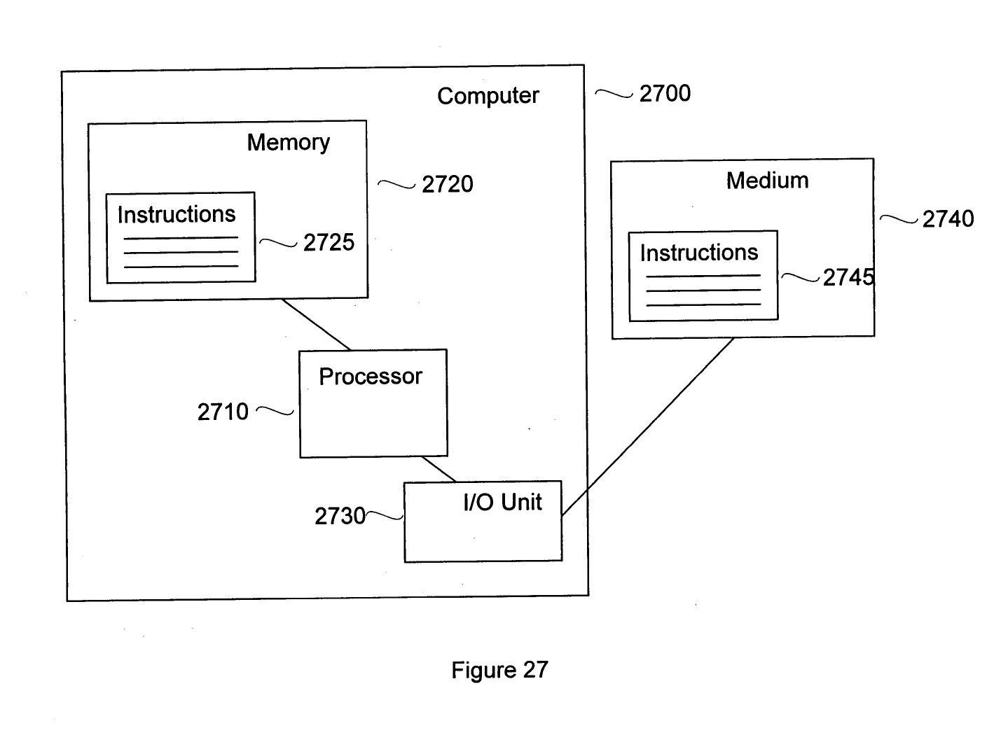

FIG. 27 shows an example of an apparatus used in some embodiments of the present invention. In FIG. 27, a medium 2740 containing Instructions 2745 may be operatively coupled to a computer 2700. For example, instructions 2745 may contain the steps in an embodiment of a method of the present invention. In particular, instructions 2745 in a specific implementation may comprise the instructions corresponding to the steps carried out by the CRM in any of FIGS. 19-21 and 24-26, or the steps carried out by the dually enabled resource in any of FIGS. 24-26. In the example depicted in FIG. 27, computer 2700 contains a processor 2710 which is coupled to an input/output unit 2730 and a memory 2720. Memory 2720 may also have instructions 2725, which correspond to the steps in an embodiment of a method of the present invention. In a specific implementation, instructions 2745 of medium 2740 may be copied into memory 2720.

Variations to the embodiments discussed above will be apparent to those skilled in the art based on the present disclosure. Such variations are within the scope of embodiments of the invention.

In a variation of embodiments discussed above, actions discussed above as being taken by a resource of the HAN may be taken by a local resource manager of the relevant resource. In another variation, the control protocol that is used by CRM-aware resources may be a superset of the control protocol that is used by non-CRM aware resources. In such a variation, the former protocol may use UPnP A/V commands and statements to control UPnP A/V source and rendering services, but extensions to effect the protocol used by CRM. Such variations of the embodiments discussed above are within the scope of the present invention.

Additionally, the structures shown and discussed in apparatus embodiments of the invention are exemplary only and the functions performed by these structures may be performed by any number of structures, as is known to those of skill in the art in view of this specification. All of such possible variations are within the scope and spirit of embodiments of the invention and the appended claims.

Propagating signals embodied in a medium, such as a carrier wave or other carrier medium, that are products of embodiments of methods of the invention, or products of the use of embodiments of systems or devices of the present invention, are within the scope and spirit of the present invention and the appended claims. Similarly, any medium containing instructions that are readable by a processor and that, when executed by the processor, perform the steps of method embodiments of the present invention, are also within the scope and spirit of the present invention and the appended claims.

Other variations and modifications of the present invention are possible, given the above written description and the appended drawings. Persons skilled in the art will recognize from these that the invention is not limited to the embodiments described, and may be practiced with modifications and alterations limited only by the spirit and scope of the appended claims which are intended to cover such modifications and alterations, so as to afford broad protection to the invention and its equivalents.

What is claimed is:

1. In a Home Area Network comprising a centralized resource manager and a plurality of resources including at least one CRM-aware resource and at least one non-CRM aware resource, a method for supporting the at least one non-CRM aware resource comprising:
detecting a request made by the non-CRM aware resource to the at least one CRM-aware resource for use of the at least one CRM-aware resource;
determining to grant permission to fulfill the request; and
transmitting a permission message to the at least one CRM-aware resource granting permission for the use, wherein the centralized resource manager comprises a reservations database and is configured to carry out instructions, the instructions comprising:
receiving a user request and a time-usage indication associated with the user request for processing of media content;
identifying, responsive to the user request, the time-usage indication associated with the user request, and pre-existing entries in the reservations database, a subset of the plurality of resources for fulfilling the user request; and
storing in the reservations database:
a representation of the identified subset of the plurality of resources, and
a representation of the time-usage indication associated with the user request.

2. The method of claim 1 wherein the detecting, determining and transmitting steps are carried out by the centralized resource manager.

3. The method of claim 2 further comprising:
detecting a presence of the at least one CRM-aware resource in the Home Area Network; and
registering the at least one CRM-aware resources in an active-devices list.

4. The method of claim 2 wherein the at least one non-CRM aware resource is not responsive to the centralized resource manager.

5. The method of claim 2 wherein the determining step is responsive to the request made by the at least one non-CRM aware resource, including timing requirement information of the request made by the at least one non-CRM aware resource, and the pre-existing entries in the reservations database.

6. The method of claim 2 wherein the at least one CRM-aware resource implements a first control protocol shared with the at least one non-CRM aware resource and a second control protocol shared with the centralized resource manager that is not compatible with the first control protocol.

7. The method of claim 2 additionally comprising transmitting a revocation message to the at least one CRM-aware resource revoking the permission for the use.

8. The method of claim 2 wherein the at least one non-CRM aware resource is a UPnP resource.

9. In a Home Area Network comprising a centralized resource manager and a plurality of resources including at least one CRM-aware resource and at least one non-CRM aware resource, a method for supporting the at least one non-CRM aware resource comprising:
detecting a request made by the at least one non-CRM aware resource to the at least one CRM-aware resource for use of the at least one CRM-aware resource;
determining the presence of a conflict with the requested use; and
transmitting a termination message to the at least one CRM-aware resource relating to the requested use,
wherein the centralized resource manager comprises a reservations database and is configured to carry out instructions, the instructions comprising:
receiving a user request and a time-usage indication associated with the user request for processing of media content;
identifying, responsive to the user request, the time-usage indication associated with the user request, and pre-existing entries in the reservations database, a subset of the plurality of resources for fulfilling the user request; and
storing in the reservations database:
a representation of the identified subset of the plurality of resources, and
a representation of the time-usage indication associated with the user request.

10. The method of claim 9 wherein the detecting, determining and transmitting steps are carried out by the centralized resource manager.

11. The method of claim 10 further comprising:
detecting a presence of the at least one CRM-aware resource in the Home Area Network; and
registering the at least one CRM-aware resources in an active-devices list.

12. The method of claim 10 wherein the determining step is carried out responsive to the pre-existing entries in the reservations database.

13. The method of claim 10 wherein the at least one non-CRM aware resource is not responsive to the centralized resource manager.

14. The method of claim 10 wherein the at least one CRM-aware resource implements a first control protocol shared with the at least one non-CRM aware resource and a second control protocol shared with the centralized resource manager that is not compatible with the first control protocol.

15. The method of claim 10 wherein the at least one non-CRM aware resource is a UPnP resource.

16. In a Home Area Network comprising a centralized resource manager and a plurality of resources including at least one CRM-aware resource and at least one non-CRM aware resource, a method for supporting the at least one non-CRM aware resource comprising:
receiving a request from the at least one non-CRM aware resource for use of the at least one CRM-aware resource;
transmitting a notification message to the centralized resource manager relating to the requested use; and
providing the requested use to the at least one non-CRM aware resource, wherein the centralized resource manager comprises a reservations database and is configured to carry out instructions, the instructions comprising:
receiving a user request and a time-usage indication associated with the user request for processing of media content;
identifying, responsive to the user request, the time-usage indication associated with the user request, and pre-existing entries in the reservations database, a subset of the plurality of resources for fulfilling the user request; and
storing in the reservations database:
a representation of the identified subset of the plurality of resources, and
a representation of the time-usage indication associated with the user request.

17. The method of claim 16 wherein the steps of receiving the request from the at least one non-CRM aware resource, transmitting and providing are carried out by the at least one CRM-aware resource.

18. The method of claim 17 further comprising:
receiving a permission message from the centralized resource manager granting permission to fulfill the requested use, wherein the providing step is carried out only after the step of receiving the permission message.

19. The method of claim 18 further comprising:
receiving a revocation message from the centralized resource manager revoking the permission to fulfill the requested use; and
terminating provision of the requested use.

20. The method of claim 17 further comprising:
receiving a termination message from the centralized resource manager relating to the requested use; and
terminating the requested use.

21. The method of claim 20 wherein the non-CRM aware resource is a UPnP resource.

22. In a Home Area Network comprising a centralized resource manager and a plurality of resources including at least one CRM-aware resource and at least one non-CRM aware resource, a method for supporting the at least one non-CRM aware resource comprising:
receiving a first request from the at least one non-CRM aware resource for use of the at least one CRM-aware resource;
initiating provision of the first requested use to the at least one non-CRM aware resource;
receiving a second request from the centralized resource manager for provision of a service to at least one other CRM-aware resource of the HAN;
terminating provision of the first requested use; and
initiating provision of the second requested use to the at least one other CRM-aware resource,
wherein the centralized resource manager comprises a reservations database and is configured to carry out instructions, the instructions comprising:
receiving a user request and a time-usage indication associated with the user request for processing of media content;
identifying, responsive to the user request, the time-usage indication associated with the user request, and pre-existing entries in the reservations database, a subset of the plurality of resources for fulfilling the user request; and
storing in the reservations database:
a representation of the identified subset of the plurality of resources, and
a representation of the time-usage indication associated with the user request.

23. The method of claim 22 wherein the receiving steps and the initiating steps are carried out by the at least one CRM-aware resource.

24. The method of claim 23 wherein the non-CRM resource is a UPnP resource.

25. In a Home Area Network comprising a plurality of resources including at least one CRM-aware resource and at least one non-CRM aware resource, a centralized control manager comprising programmed logic configured to implement a first control protocol for providing centralized control of the at least one CRM-aware resource and a second control protocol for communicating with the at least one non-CRM aware resource.
